(19) United States
(12) Patent Application Publication
(10) Pub. No.: US 2019/0096248 A1
(43) Pub. Date: Mar. 28, 2019

(54) VEHICLE TRAVELLING PREDICTION METHOD, VEHICLE TRAVELLING PREDICTION DEVICE AND ON-BOARD SMART SYSTEM

(71) Applicant: BOE TECHNOLOGY GROUP CO., LTD., Beijing (CN)

(72) Inventors: Kairan LIU, Beijing (CN); Jiantao LIU, Beijing (CN); Wenbo LI, Beijing (CN)

(73) Assignee: BOE TECHNOLOGY GROUP CO., LTD., Beijing (CN)

(21) Appl. No.: 15/745,020

(22) PCT Filed: Jun. 7, 2017
(86) PCT No.: PCT/CN2017/087370

§ 371 Date: Jan. 15, 2018

(30) Foreign Application Priority Data
Jun. 17, 2016 (CN) 201610439274.X

(51) Int. Cl. G08G 1/0962; G08G 1/0967; G08G 1/16

(52) U.S. Cl. CPC G08G 1/09623; G08G 1/096725; G08G 1/166; G08G 1/096716

(57) ABSTRACT

A vehicle travelling prediction method includes: acquiring a first distance between a current vehicle and an intersection where a traffic light is located in an advancing direction of the current vehicle, and determining a state of the traffic light; when the traffic light is in a first state where the current vehicle is allowed to cross the intersection, acquiring a first time period within which the traffic light is changed to be in a second state where the current vehicle is not allowed to cross the intersection; acquiring a detection result of a vehicle in a same lane, the detection result including a detection result of a vehicle behind the current vehicle and/or an obstacle vehicle; and outputting a prediction result indicating whether or not the current vehicle is capable of crossing the intersection in accordance with the first time period, the first distance and the detection result.

### CROSS-REFERENCE TO RELATED APPLICATION

The present application claims a priority of the Chinese patent application No. 201610439274.X filed on Jun. 17, 2016 and entitled “vehicle travelling prediction method, vehicle travelling prediction device and on-board smart system”, which is incorporated herein by reference in its entirety.

### TECHNICAL FIELD

The present disclosure relates to the field of vehicle travelling prediction technology, in particular to a vehicle travelling prediction method, a vehicle travelling prediction device and an on-board smart system.

### BACKGROUND

Currently, traffic pressure is increasing more and more. It is difficult to control a distance between vehicles, and thereby traffic accidents (e.g., rear-end collision) may occur. For example, when a traffic light is about to change (e.g., from a green light to a red light), a driver may be in hurry to cross an intersection prior to the red light and thereby the traffic accident may occur. Particularly, sometimes it is difficult to determine whether or not there is enough time for the vehicle to cross the intersection in accordance with the remaining time of the green light. When the vehicle is to be slowed down and wait for a next green light, it may waste time and a traffic jam may occur. When the vehicle is to be accelerated so as to cross the street, the vehicle may run the red light and even a rear-end collision with another vehicle ahead may occur, or it is necessary to slam on the brake before the vehicle reaches a stop line so as to prevent running the red light (at this time, a rear-end collision with a vehicle behind may occur). In the related art, there is no scheme capable of effectively indicating the vehicle to cross the intersection successfully. Hence, the traffic efficiency is relatively low, and even the probability of traffic accidents increases.

### SUMMARY

A main object of the present disclosure is to provide a vehicle travelling prediction method, a vehicle travelling prediction device and an on-board smart system, so as to improve the traffic efficiency and reduce the probability of traffic accidents.

In one aspect, the present disclosure provides in some embodiments a vehicle travelling prediction method, including steps of: acquiring a first distance between a current vehicle and an intersection where a traffic light is located in an advancing direction of the current vehicle, and determining a state of the traffic light; when the traffic light is in a first state where the current vehicle is allowed to cross the intersection, acquiring a first time period t1 within which the traffic light is changed to be in a second state where the current vehicle is not allowed to cross the intersection; acquiring a detection result of a vehicle in a same lane, the detection result of the vehicle in the same lane including a detection result of a vehicle behind the current vehicle and/or a detection result of an obstacle vehicle; and outputting a prediction result indicating whether or not the current vehicle is capable of crossing the intersection in accordance with the first time period t1, the first distance and the detection result of the vehicle in the same lane.

In a possible embodiment of the present disclosure, the step of acquiring the first distance between the current vehicle and the intersection where the traffic light is located in the advancing direction of the current vehicle includes detecting whether or not there is the traffic light within a first predetermined distance from the current vehicle in the advancing direction of the current vehicle, and when there is the traffic light, detecting the first distance between the current vehicle and the intersection where the traffic light is located. The step of acquiring the first time period t1 within which the traffic light is changed to be in the second state where the current vehicle is not allowed to cross the intersection includes detecting the first time period t1 within which the traffic light is changed to be in the second state.

In a possible embodiment of the present disclosure, prior to the step of acquiring the detection result of the vehicle in the same lane, the vehicle travelling prediction method further includes detecting whether or not there is the vehicle behind the current vehicle, and when there is the vehicle behind the current vehicle, detecting a speed of the vehicle behind the current vehicle, a second distance between the vehicle behind the current vehicle and the intersection, and a third distance between the current vehicle and the vehicle behind the current vehicle, so as to acquire the detection result of the vehicle behind the current vehicle. The step of outputting the prediction result indicating whether or not the current vehicle is capable of crossing the intersection in accordance with the first time period t1, the first distance and the detection result of the vehicle in the same lane includes acquiring and outputting a first prediction result indicating whether or not the current vehicle is capable of crossing the intersection in accordance with the first time period t1, the first distance and the detection result of the vehicle behind the current vehicle. The prediction result indicating whether or not the current vehicle is capable of crossing the intersection includes the first prediction result.

In a possible embodiment of the present disclosure, the step of acquiring and outputting the first prediction result indicating whether or not the current vehicle is capable of crossing the intersection in accordance with the first time period t1, the first distance and the detection result of the vehicle behind the current vehicle includes: determining a first predetermined speed in accordance with the speed of the vehicle behind the current vehicle included in the detection result of the vehicle behind the current vehicle; calculating a first estimated travelling time period t01 in accordance with the second distance and the first predetermined speed, the first estimated travelling time period t01 being the second distance divided by the first predetermined speed; comparing the first time period t1 with the first estimated travelling time period t01; when the first time period t1 is smaller than the first estimated travelling time period t01, outputting the prediction result indicating that the vehicle behind the current vehicle is incapable of crossing the intersection before the traffic light is changed to be in the second state; and when the first time period t1 is greater than or equal to the first estimated travelling time period t01, calculating a threshold speed in accordance with the first time period t1, the first distance, the third distance and the first predetermined speed, so as to output the prediction result indicating that the vehicle behind the current vehicle is capable of crossing the intersection at a speed greater than or equal to the first predetermined speed before the traffic light changes when a speed of the current vehicle is greater than or equal to the threshold speed, thereby to prompt the current vehicle to adjust its speed.

In a possible embodiment of the present disclosure, the vehicle travelling prediction method further includes, when the traffic light is in the first state where the current vehicle is allowed to cross the intersection, calculating a second estimated travelling time period t02 in accordance with travelling information about the current vehicle and the first distance.

In a possible embodiment of the present disclosure, prior to the step of acquiring the detection result of the vehicle in the same lane, the vehicle travelling prediction method further includes determining whether or not there is the obstacle vehicle between the current vehicle and the intersection in the advancing direction of the current vehicle, and when there is the obstacle vehicle, detecting a speed of the obstacle vehicle and a fourth distance between the current vehicle and the obstacle vehicle, so as to acquire the detection result of the obstacle vehicle. The step of outputting the prediction result indicating whether or not the current vehicle is capable of crossing the intersection in accordance with the first time period t1, the first distance and the detection result of the vehicle in the same lane includes outputting a second prediction result indicating whether or not the current vehicle is capable of crossing the intersection in accordance with the first time period t1, the second estimated travelling time period t02 and the detection result of the obstacle vehicle. The prediction result indicating whether or not the current vehicle is capable of crossing the intersection includes the second prediction result.

In a possible embodiment of the present disclosure, the step of calculating the second estimated travelling time period t02 in accordance with the travelling information about the current vehicle and the first distance includes: determining a second predetermined speed in accordance with speed information included in the travelling information about the current vehicle; and calculating the second estimated travelling time period t02 in accordance with the first distance and the second predetermined speed, the second estimated travelling time period t02 being the first distance divided by the second predetermined speed.

In a possible embodiment of the present disclosure, the step of acquiring and outputting the second prediction result indicating whether or not the current vehicle is capable of crossing the intersection in accordance with the first time period t1, the second estimated travelling time period t02 and the detection result of the obstacle vehicle includes: comparing the first time period t1 with the second estimated travelling time period t02; when the first time period t1 is greater than or equal to the second estimated travelling time period t02 and there is no obstacle vehicle between the current vehicle and the intersection in the advancing direction of the current vehicle, outputting the prediction result indicating that the current vehicle is capable of crossing the intersection at a speed greater than or equal to the second predetermined speed before the traffic light is changed to be in the second state; and when the first time period t1 is greater than or equal to the second estimated travelling time period t02 and there is the obstacle vehicle between the current vehicle and the intersection in the advancing direction of the current vehicle, detecting the fourth distance between the current vehicle and the obstacle vehicle and the speed of the obstacle vehicle, and acquiring and outputting the prediction result in accordance with the first time period t1, the second predetermined speed, the fourth distance and the speed of the obstacle vehicle.

In a possible embodiment of the present disclosure, when the first time period t1 is greater than or equal to the second estimated travelling time period t02 and there is no obstacle vehicle between the current vehicle and the intersection in the advancing direction of the current vehicle, the vehicle travelling prediction method further includes outputting a prompt information indicating that there is no obstacle vehicle in front of the current vehicle and the current vehicle is capable of being accelerated so as to facilitate the vehicle behind the current vehicle to cross the intersection.

In a possible embodiment of the present disclosure, the step of outputting the second prediction result indicating that the current vehicle is capable of crossing the intersection in accordance with the first time period t1, the second predetermined speed, the fourth distance and the speed of the obstacle vehicle includes: comparing the second predetermined speed and the speed of the obstacle vehicle; when the second predetermined speed is smaller than or equal to the speed of the obstacle vehicle, outputting the prediction result indicating that the current vehicle is capable of crossing the intersection at a speed greater than or equal to the second predetermined speed before the traffic light is changed to be in the second state; when the second predetermined speed is greater than the speed of the obstacle vehicle, calculating a second time period t2 within which the current vehicle is to run at the second predetermined speed in such a manner as to keep a predetermined safe distance from the obstacle vehicle in accordance with the second predetermined speed, the fourth distance and the speed of the obstacle vehicle, and comparing the second time period t2 with the first time period t1; and when t2 is greater than or equal to t1, outputting the prediction result indicating that the current vehicle is capable of crossing the intersection at a speed greater than or equal to the second predetermined speed before the traffic light is changed to be in the second state; when t2 is smaller than t1, calculating a third time period t3 within which the current vehicle is to cross the intersection at the speed of the obstacle vehicle when the predetermined safe distance is kept between the current vehicle and the obstacle vehicle; comparing t1 with t2+t3; when t1 is greater than or equal to t2+t3, outputting the prediction result indicating that the current vehicle is capable of crossing the intersection before the traffic light is changed to be in the second state; and when t1 is smaller than t2+t3, outputting the prediction result indicating that the current vehicle is incapable of crossing the intersection before the traffic light is changed to be in the second state.

In a possible embodiment of the present disclosure, the vehicle travelling prediction method further includes, when t1 is greater than or equal to t2+t3, outputting information indicating that there is the obstacle vehicle in front of the current vehicle but the current vehicle is capable of being accelerated so as to facilitate the vehicle behind the current vehicle to cross the intersection before the traffic light is changed to be in the second state, and when t1 is smaller than t2+t3, outputting information indicating that there is the obstacle vehicle in front of the current vehicle and the current vehicle is incapable of being accelerated so as to facilitate the vehicle behind the current vehicle to cross the intersection before the traffic light is changed to be in the second state.

In a possible embodiment of the present disclosure, the step of detecting the fourth distance between the current vehicle and the obstacle vehicle and the speed of the obstacle vehicle includes detecting the fourth distance between the current vehicle and the obstacle vehicle and the speed of the obstacle vehicle through a frequency-modulated continuous-wave radar.

In a possible embodiment of the present disclosure, the vehicle travelling prediction method further includes, when the first time period t1 is smaller than the second estimated travelling time period t02, outputting the prediction result indicating that the current vehicle is incapable of crossing the intersection before the traffic light is changed to be in the second state.

In a possible embodiment of the present disclosure, the vehicle travelling prediction method further includes, when the traffic light is in the second state where the current vehicle is not allowed to cross the intersection, detecting and outputting a time period t4 within which the traffic light is changed to be in the first state where the current vehicle is allowed to cross the intersection.

In a possible embodiment of the present disclosure, the vehicle travelling prediction method further includes detecting whether or not there is a vehicle of a specific type within a second predetermined distance from the current vehicle, and when there is the vehicle of the specific type, detecting travelling information about the vehicle of the specific type and outputting a corresponding prompt.

In a possible embodiment of the present disclosure, the step of detecting the travelling information about the vehicle of the specific type and outputting the corresponding prompt includes: when there is the vehicle of the specific type, determining whether the vehicle of the specific type is ahead of or behind the current vehicle; when the vehicle of the specific type is behind the current vehicle, outputting the prompt indicating that the current vehicle is capable of changing its lane so as to avoid the vehicle of the specific type; and when the vehicle of the specific type is ahead of the current vehicle, detecting a fifth distance between the current vehicle and the vehicle of the specific type, determining whether or not the current vehicle is capable of crossing the intersection at a speed greater than or equal to the second predetermined speed in accordance with the second predetermined speed, the travelling information about the vehicle of the specific type, the first distance and the fifth distance, and outputting the corresponding prediction result.

In a possible embodiment of the present disclosure, the second predetermined speed is a speed upper limit, a current speed of the current vehicle or an average speed of the current vehicle.

In a possible embodiment of the present disclosure, the first predetermined speed is a speed upper limit, a current speed of the vehicle behind the current vehicle or an average speed of the vehicle behind the current vehicle.

In another aspect, the present disclosure provides in some embodiments a vehicle travelling prediction device, including: a traffic light determination unit configured to determine a state of a traffic light; an acquisition unit configured to acquire a first distance between a current vehicle and an intersection where the traffic light is located in an advancing direction of the current vehicle, and when the traffic light is in a first state where the current vehicle is allowed to cross the intersection, acquire a first time period t1 within which the traffic light is changed to be in a second state where the current vehicle is not allowed to cross the intersection and acquire a detection result of a vehicle in a same lane, the detection result of the vehicle in the same lane including a detection result of a vehicle behind the current vehicle and/or a detection result of an obstacle vehicle; and an output unit configured to output a prediction result indicating whether or not the current vehicle is capable of crossing the intersection in accordance with the first time period t1, the first distance and the detection result of the vehicle in the same lane.

In a possible embodiment of the present disclosure, the vehicle travelling prediction device further includes a traffic light detection unit, and the acquisition unit includes a first distance measurement unit. The traffic light detection unit is configured to detect whether or not there is the traffic light within a first predetermined distance from the current vehicle in the advancing direction of the current vehicle, and when there is the traffic light, output a first control signal. The traffic light determination unit is connected to the traffic light detection unit and further configured to, upon the receipt of the first control signal, determine the state of the traffic light, and when the traffic light is in the first state where the current vehicle is allowed to cross the intersection, detect the first time period t1 within which the traffic light is changed to be in the second state where the current vehicle is not allowed to cross the intersection. The first distance measurement unit is connected to the traffic light detection unit and configured to, upon the receipt of the first control signal, detect the first distance between the current vehicle and the intersection where the traffic light is located.

In a possible embodiment of the present disclosure, the acquisition unit includes a first detection unit and a first calculation unit. The first detection unit is configured to detect whether or not there is the vehicle behind the current vehicle, and when there is the vehicle behind the current vehicle, detect a speed of the vehicle behind the current vehicle, a second distance between the vehicle behind the current vehicle and the intersection, and a third distance between the current vehicle and the vehicle behind the current vehicle, so as to acquire the detection result of the vehicle behind the current vehicle. The first calculation unit is connected to the traffic light determination unit, the first distance measurement unit and the first detection unit, and configured to acquire a first prediction result indicating whether or not the current vehicle is capable of crossing the intersection in accordance with the first time period t1, the first distance and the detection result of the vehicle behind the current vehicle. The prediction result indicating whether or not the current vehicle is capable of crossing the intersection includes the first prediction result. The output unit is connected to the first calculation unit and further configured to output the first prediction result.

In a possible embodiment of the present disclosure, the first calculation unit includes a first predetermined speed determination module, a first estimated travelling time period calculation module, a first comparison module and a first calculation module. The first predetermined speed determination module is connected to the first detection unit and configured to determine a first predetermined speed of the vehicle behind the current vehicle in accordance with the speed of the vehicle behind the current vehicle included in the detection result of the vehicle behind the current vehicle. The first estimated travelling time period calculation module is connected to the first detection unit and the first predetermined speed determination module, and configured to calculate a first estimated travelling time period t01 in accordance with the second distance and the first predetermined speed, the first estimated travelling time period t01 being the second distance divided by the first predetermined speed. The first comparison module is connected to the first estimated travelling time period calculation module and the traffic light determination unit, and configured to compare the first time period t1 with the first estimated travelling time period t01, when the first time period t1 is smaller than the first estimated travelling time period t01, output a twelfth control signal, and when the first time period t1 is greater than or equal to the first estimated travelling time period t01, output a thirteenth control signal. The first calculation module is connected to the first comparison module, the traffic light determination unit, the first distance measurement unit and the first detection unit, and configured to, upon the receipt of the thirteenth control signal, calculate a threshold speed in accordance with the first time period t1, the first distance, the third distance and the first predetermined speed, and output a fourteenth control signal. The output unit is further connected to the first comparison module and the first calculation module, and further configured to, upon the receipt of the twelfth control signal, output the prediction result indicating that the vehicle behind the current vehicle is incapable of crossing the intersection before the traffic light is changed to be in the second state, and upon the receipt of the fourteenth control signal, output the prediction result indicating that the vehicle behind the current vehicle is capable of crossing the intersection at a speed greater than or equal to the first predetermined speed before the traffic light changes when a speed of the current vehicle is greater than or equal to the threshold speed, thereby to prompt the current vehicle to adjust its speed.

In a possible embodiment of the present disclosure, the acquisition unit further includes a travelling information detection unit and a second estimated travelling time period calculation unit. The travelling information detection unit is configured to detect travelling information about the current vehicle. The second estimated travelling time period calculation unit is configured to calculate a second estimated travelling time period t02 in accordance with the travelling information about the current vehicle and the first distance.

In a possible embodiment of the present disclosure, the acquisition unit further includes a second detection unit and a second calculation unit. The second detection unit is configured to determine whether or not there is the obstacle vehicle between the current vehicle and the intersection in the advancing direction of the current vehicle, and when there is the obstacle vehicle, detect a speed of the obstacle vehicle and a fourth distance between the current vehicle and the obstacle vehicle, so as to acquire the detection result of the obstacle vehicle. The second calculation unit is connected to the traffic light determination unit, the second estimated travelling time period calculation unit and the second detection unit, and configured to acquire a second prediction result indicating whether or not the current vehicle is capable of crossing the intersection in accordance with the first time period t1, the second estimated travelling time period t02 and the detection result of the obstacle vehicle. The prediction result indicating whether or not the current vehicle is capable of crossing the intersection includes the second prediction result. The output unit is further connected to the second calculation unit and further configured to output the second prediction result.

In a possible embodiment of the present disclosure, the travelling information about the current vehicle includes speed information. The vehicle travelling prediction device further includes a second predetermined speed determination unit connected to the travelling information detection unit and configured to determine a second predetermined speed in accordance with the speed information. The second estimated travelling time period calculation unit is further connected to the second predetermined speed determination unit and further configured to calculate the second estimated travelling time period t02 in accordance with the first distance and the second predetermined speed. The second estimated travelling time period t02 is the first distance divided by the second predetermined speed.

In a possible embodiment of the present disclosure, the second calculation unit includes a second comparison module and a second calculation module. The second detection unit includes a first detection module and a second detection module. The second comparison module is connected to the traffic light determination unit and the second estimated travelling time period calculation unit, and configured to compare the first time period t1 with the second estimated travelling time period t02, and when the first time period t1 is greater than or equal to the second estimated travelling time period t02, output a second control signal. The first detection module is connected to the second comparison module and configured to, upon the receipt of the second control signal, detect whether or not there is the obstacle vehicle between the current vehicle and the intersection in the advancing direction of the current vehicle, when there is the obstacle vehicle, output a third control signal, and when there is no obstacle vehicle, output a fourth control signal. The second detection module is connected to the first detection module and configured to, upon the receipt of the third control signal, detect the fourth distance between the current vehicle and the obstacle vehicle and the speed of the obstacle vehicle. The second calculation module is connected to the second detection module and the traffic light determination unit, and configured to acquire the corresponding prediction result in accordance with the first time period t1, the second predetermined speed, the fourth distance and the speed of the obstacle vehicle. The output unit is further connected to the second calculation module and the first detection module, and further configured to, upon the receipt of the fourth control signal, output the prediction result indicating that the current vehicle is capable of crossing the intersection at a speed greater than or equal to the second predetermined speed before the traffic light is changed to be in the second state, and upon the receipt of the third control signal, output the prediction result acquired by the second calculation module.

In a possible embodiment of the present disclosure, the output unit is further connected to the first detection module and further configured to, upon the receipt of the fourth control signal, output prompt information indicating that there is no obstacle vehicle in front of the current vehicle and the current vehicle is capable of being accelerated so as to facilitate the vehicle behind the current vehicle to cross the intersection.

In a possible embodiment of the present disclosure, the second calculation module includes a first comparison sub-module, a first calculation sub-module, a second comparison sub-module, a second calculation sub-module and a third comparison sub-module. The first comparison sub-module is configured to compare the second predetermined speed and the speed of the obstacle vehicle, when the second predetermined speed is smaller than or equal to the speed of the obstacle vehicle, output a fifth control signal, and when the second predetermined speed is greater than the speed of the obstacle vehicle, output a sixth control signal. The first calculation sub-module is connected to the first comparison sub-module and configured to, upon the receipt of the sixth control signal, calculate a second time period t2 within which the current vehicle is to run at the second predetermined speed in such a manner as to keep a predetermined safe distance from the obstacle vehicle in accordance with the second predetermined speed, the fourth distance and the speed of the obstacle vehicle. The second comparison sub-module is connected to the first calculation sub-module and the traffic light determination unit, and configured to compare the second time period t2 with the first time period t1, when t2 is greater than or equal to t1, output a seventh control signal, and when t2 is smaller than t1, output an eighth control signal. The second calculation sub-module is connected to the second comparison sub-module and configured to, upon the receipt of the eighth control signal, calculate a third time period t3 within which the current vehicle is to cross the intersection at the speed of the obstacle vehicle when the predetermined safe distance is kept between the current vehicle and the obstacle vehicle. The third comparison sub-module is connected to the traffic light determination unit, the first calculation sub-module and the second calculation sub-module, and configured to compare t1 with t2+t3, when t1 is greater than or equal to t2+t3, output a ninth control signal, and when t1 is smaller than t2+t3, output a tenth control signal. The output unit is further connected to the first comparison sub-module, the second comparison sub-module and the third comparison sub-module, and further configured to, upon the receipt of the fifth control signal, output the prediction result indicating that the current vehicle is capable of crossing the intersection at a speed greater than or equal to the second predetermined speed before the traffic light is changed to be in the second state, upon the receipt of the seventh control signal, output the prediction result indicating that the current vehicle is capable of crossing the intersection at a speed greater than or equal to the second predetermined speed before the traffic light is changed to be in the second state, upon the receipt of the ninth control signal, output the prediction result indicating that the current vehicle is capable of crossing the intersection before the traffic light is changed to be in the second state, and upon the receipt of the tenth control signal, output the prediction result indicating that the current vehicle is incapable of crossing the intersection before the traffic light is changed to be in the second state.

In a possible embodiment of the present disclosure, the output unit is further connected to the third comparison sub-module and further configured to, upon the receipt of the ninth control signal, output prompt information indicating that there is the obstacle vehicle in front of the current vehicle but the current vehicle is capable of being accelerated so as to facilitate the vehicle behind the current vehicle to cross the intersection before the traffic light is changed to be in the second state, and upon the receipt of the tenth control signal, output prompt information indicating that there is the obstacle vehicle in front of the current vehicle and the current vehicle is incapable of being accelerated before the traffic light is changed to be in the second state.

In a possible embodiment of the present disclosure, the second detection module is further configured to detect the fourth distance between the current vehicle and the obstacle vehicle and the speed of the obstacle vehicle through a frequency-modulated continuous-wave radar.

In a possible embodiment of the present disclosure, the second comparison module is further configured to, when the first time period t1 is smaller than the second estimated travelling time period t02, output an eleventh control signal. The output unit is further connected to the second comparison module and further configured to, upon the receipt of the eleventh control signal, output the prediction result indicating that the current vehicle is incapable of crossing the intersection before the traffic light is changed to be in the second state.

In a possible embodiment of the present disclosure, the traffic light determination unit is further configured to, when the traffic light is in the second state where the current vehicle is not allowed to cross the intersection, detect a time period t4 within which the traffic light is changed to be in the first state where the current vehicle is allowed to cross the intersection. The output unit is further connected to the traffic light determination unit and further configured to output the fourth time period t4.

In a possible embodiment of the present disclosure, the vehicle travelling prediction device further includes a third detection unit configured to detect whether or not there is a vehicle of a specific type within a second predetermined distance from the current vehicle, and when there is the vehicle of the specific type, detect travelling information about the vehicle of the specific type and output a fifteenth control signal. The output unit is further connected to the third detection unit and further configured to, upon the receipt of the fifteenth control signal, output prompt information indicating that there is the vehicle of the specific type.

In a possible embodiment of the present disclosure, the vehicle travelling prediction device further includes a determination unit, a, second distance measurement unit and a third calculation unit. The determination unit is connected to the third detection unit, and configured to, upon the receipt of the fifteenth control signal, determine whether the vehicle of the specific type is ahead of or behind the current vehicle, when the vehicle of the specific type is behind the current vehicle, output a sixteenth control signal, and when the vehicle of the specific type is ahead of the current vehicle, output a seventeenth control signal. The second distance measurement unit is connected to the determination unit and configured to, upon the receipt of the seventeenth control signal, detect a fifth distance between the current vehicle and the vehicle of the specific type. The third calculation unit is connected to the third detection unit, the first distance measurement unit, the determination unit and the second distance measurement unit, and configured to, upon the receipt of the seventeenth control signal, determine whether or not the current vehicle is capable of crossing the intersection at a speed greater than or equal to the second predetermined speed in accordance with the second predetermined speed, the travelling information about the vehicle of the specific type, the first distance and the fifth distance, and output an eighteenth control signal. The output unit is further connected to the determination unit and the third calculation unit, and further configured to, upon the receipt of the sixteenth control signal, output the prompt information indicating that the current vehicle is capable of changing its lane so as to avoid the vehicle of the specific type, and upon the receipt of the eighteenth control signal, output the corresponding prediction result so as to prompt the current vehicle to adjust its speed.

In a possible embodiment of the present disclosure, the second predetermined speed is a speed upper limit, a current speed of the current vehicle or an average speed of the current vehicle.

In a possible embodiment of the present disclosure, the first predetermined speed is a speed upper limit, a current speed of the vehicle behind the current vehicle or an average speed of the vehicle behind the current vehicle.

In a possible embodiment of the present disclosure, the output unit includes a display module configured to display the prediction result indicating whether or not the current vehicle is capable of crossing the intersection and/or a sound reminding module configured to prompt via a sound the prediction result indicating whether or not the current vehicle is capable of crossing the intersection.

In a possible embodiment of the present disclosure, the traffic light detection unit includes a camera unit or a position detection unit. When the traffic light detection unit includes the camera unit, the camera unit is configured to take an image so as to determine whether or not there is the traffic light within the first predetermined distance from the current vehicle in the advancing direction of the current vehicle. When the traffic light detection unit includes the position detection unit, the position detection unit is configured to detect position information about the current vehicle, and compare the position information with a pre-stored traffic light position, so as to determine whether or not there is the traffic light within the first predetermined distance from the current vehicle in the advancing direction of the current vehicle.

In a possible embodiment of the present disclosure, the third detection unit includes a sound recognition module configured to determine whether or not there is the vehicle of the specific type within the second predetermined distance from the current vehicle through a sound of a specific type and a light recognition module configured to determine whether or not there is the vehicle of the specific type within the second predetermined distance from the current vehicle through a blinking light beam of a specific type.

In yet another aspect, the present disclosure provides in some embodiments an on-board smart system including the above-mentioned vehicle travelling prediction device.

In a possible embodiment of the present disclosure, the on-vehicle smart system further includes an on-board speed detection unit configured to detect a current speed of a vehicle in real time. When a second predetermined speed is the current speed of the vehicle, the on-board speed detection unit is further configured to transmit the current speed of the vehicle to the second calculation unit of the vehicle travelling prediction device.

In a possible embodiment of the present disclosure, the on-board smart system further includes an on-board positioning unit configured to detect a position of the vehicle in real time. When the traffic light detection unit of the vehicle travelling prediction device includes the position detection unit, the position detection unit is connected to the on-board positioning unit and configured to receive the position of the vehicle from the on-board positioning unit.

In a possible embodiment of the present disclosure, the on-board smart system further includes an on-board display unit. When the output unit of the vehicle travelling prediction device includes the display module, the display module is configured to output the prediction result to the on-board display unit, so that the on-board display unit displays the prediction result.

According to the vehicle travelling prediction method, the vehicle travelling prediction device and the on-board smart system in the embodiments of the present disclosure, through detecting the traffic light and determining the state of the traffic light, it is able to, when the traffic light is in the state where the current vehicle is allowed to cross the intersection, determine whether or not the current vehicle is capable of crossing the intersection before the traffic light is changed to be in the second state in accordance with the time period within which the traffic light is changed to be in the second state where the current vehicle is not allowed to cross the intersection, the first estimated travelling time period and the detection result of the vehicle in the same lane, and output the prediction result indicating whether or not the current vehicle is capable of crossing the intersection, thereby to facilitate the driver to select a corresponding driving mode in accordance with the prediction result. To be specific, when there is the vehicle behind the current vehicle, it is able to acquire, in accordance with the time period within which the traffic light is changed to be in the second state where the current vehicle is not allowed to cross the intersection, the first distance between the current vehicle and the intersection where the traffic light is located and the detection result of the vehicle behind the current vehicle, a first prediction result indicating whether or not the vehicle behind the current vehicle is capable of crossing the intersection at the speed greater than or equal to the first predetermined speed before the traffic light is changed to be in the second state when the speed of the current vehicle is greater than or equal to the threshold speed. As a result, it is able to facilitate the driver to select an appropriate speed, so as to cross the intersection and meanwhile facilitate the vehicle behind the current vehicle to cross the intersection before the traffic light is changed to be in the second state, thereby to improve the traffic efficiency.

### BRIEF DESCRIPTION OF THE DRAWINGS

FIG. 1 is a flow chart of a vehicle travelling prediction method according to one embodiment of the present disclosure;

FIG. 2 is another flow chart of the vehicle travelling prediction method according to one embodiment of the present disclosure;

FIG. 3 is a flow chart of a step of acquiring and outputting a first prediction result indicating whether or not a current vehicle is capable of crossing a first intersection in accordance with a first time period t1 and a detection result of a vehicle behind the current vehicle according to one embodiment of the present disclosure;

FIG. 4 is yet another flow chart of the vehicle travelling prediction method according to one embodiment of the present disclosure;

FIG. 5 is a flow chart of a step of acquiring and outputting a second prediction result indicating whether or not the current vehicle is capable of crossing a second intersection in accordance with the first time period t1, a second estimated travelling time period t02 and a detection result of an obstacle vehicle according to one embodiment of the present disclosure;

FIG. 6 is a flow chart of a step of acquiring and outputting a corresponding prediction result in accordance with the first time period t1, a second predetermined speed, a fourth distance and a speed of the obstacle vehicle according to one embodiment of the present disclosure;

FIG. 7 is a block diagram of a vehicle travelling prediction device according to one embodiment of the present disclosure;

FIG. 8 is another block diagram of the vehicle travelling prediction device according to one embodiment of the present disclosure;

FIG. 9 is a block diagram of a first calculation unit of the vehicle travelling prediction device according to one embodiment of the present disclosure;

FIG. 10 is yet another block diagram of the vehicle travelling prediction device according to one embodiment of the present disclosure;

FIG. 11 is a block diagram of a second calculation unit of the vehicle travelling prediction device according to one embodiment of the present disclosure;

FIG. 12 is a block diagram of a second calculation module of the second calculation unit of the vehicle travelling prediction device according to one embodiment of the present disclosure;

FIG. 13 is still yet another block diagram of the vehicle travelling prediction device according to one embodiment of the present disclosure;

FIG. 14 is still yet another block diagram of the vehicle travelling prediction device according to one embodiment of the present disclosure; and

FIG. 15 is still yet another block diagram of the vehicle travelling prediction device according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

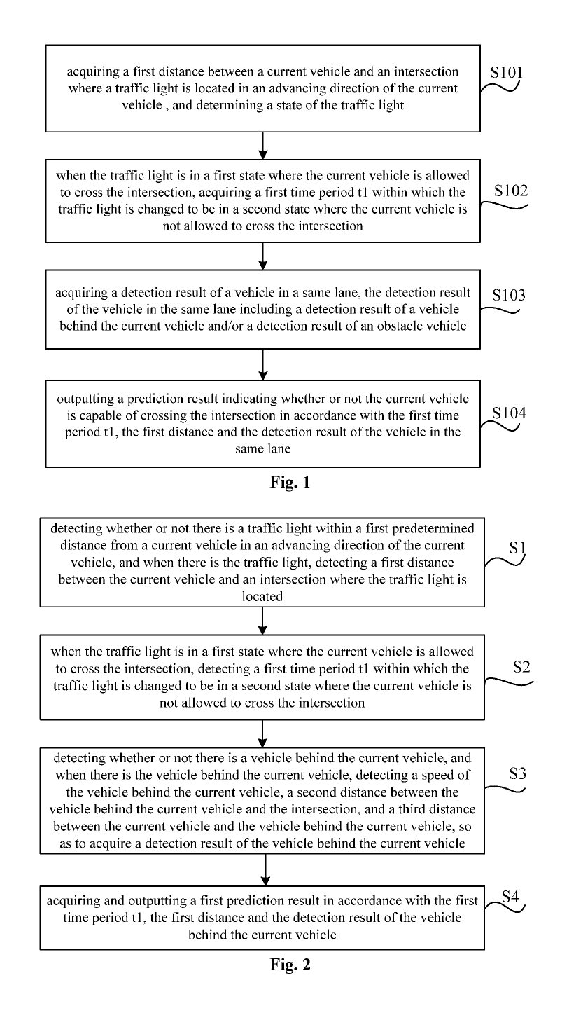

Referring to FIG. 1, the present disclosure provides in some embodiments a vehicle travelling prediction method which includes: Step S101 of acquiring a first distance between a current vehicle and an intersection in an advancing direction of the current vehicle where a traffic light is located, and determining a state of the traffic light; Step S102 of, when the traffic light is in a first state where the current vehicle is allowed to cross the intersection, acquiring a first time period t1 within which the traffic light is changed to be in a second state where the current vehicle is not allowed to cross the intersection; Step S103 of acquiring a detection result of a vehicle in a same lane, the detection result of the vehicle in the same lane including a detection result of a vehicle behind the current vehicle and/or a detection result of an obstacle vehicle; and Step S104 of outputting a prediction result indicating whether or not the current vehicle is capable of crossing the intersection in accordance with the first time period t1, the first distance and the detection result of the vehicle in the same lane.

In a possible embodiment of the present disclosure, relevant parameters, e.g., the first distance, the first time period t1, a speed of the vehicle behind the current vehicle or a speed of the vehicle ahead of the current vehicle may be detected by at least one sensor (e.g., a camera or a radar) mounted on the current vehicle. Of course, the current vehicle may also receive the first distance and the first time period t1 from any other vehicle when the current vehicle is capable of communicating with the other vehicle, or the first distance and the first time period t1 may be detected by a sensor arranged at the intersection and then transmitted to the current vehicle through a network. It should be appreciated that, the ways for acquiring these parameters will not be particularly defined herein.

In a possible embodiment of the present disclosure, the detection result of the vehicle behind the current vehicle represents information related to the vehicle behind the current vehicle, e.g., a speed of the vehicle behind the current vehicle, a second distance between the vehicle behind the current vehicle and the intersection, and/or a third distance between the current vehicle and the vehicle behind the current vehicle. The detection result of the obstacle vehicle represents information related to the vehicle ahead of the current vehicle, e.g., a speed of the obstacle vehicle, and a fourth distance between the current vehicle and the obstacle vehicle.

According to the embodiments of the present disclosure, it is able to provide an effective prediction result in accordance with travelling information about the vehicle ahead of the current vehicle and the vehicle behind the current vehicle, so as to facilitate the current vehicle to cross the intersection, thereby to improve the traffic efficiency and effectively prevent the occurrence of rear-end collision.

The present disclosure will be described hereinafter in more details in conjunction with the drawings.

As shown in FIG. 2, the vehicle travelling prediction method includes: Step S1 of detecting whether or not there is a traffic light within a first predetermined distance from the current vehicle in the advancing direction of the current vehicle, and when there is the traffic light, detecting the first distance between the current vehicle and the intersection where the traffic light is located and determine a state of the traffic light; Step S2 of, when the traffic light is in the first state where the current vehicle is allowed to cross the intersection, detecting the first time period t1 within which the traffic light is changed to be in the second state where the current vehicle is not allowed to cross the intersection; Step S3 of detecting whether or not there is the vehicle behind the current vehicle, and when there is the vehicle behind the current vehicle, detecting a speed of the vehicle behind the current vehicle, a second distance between the vehicle behind the current vehicle and the intersection, and a third distance between the current vehicle and the vehicle behind the current vehicle, so as to acquire the detection result of the vehicle behind the current vehicle; and Step S4 of acquiring and outputting a first prediction result indicating whether or not the current vehicle is capable of crossing the intersection in accordance with the first time period t1, the first distance and the detection result of the vehicle behind the current vehicle.

According to the vehicle travelling prediction method in the embodiments of the present disclosure, through detecting the traffic light and determining the state of the traffic light, it is able to, when the traffic light is in the state where the current vehicle is allowed to cross the intersection, detect the first time period t1 within which the traffic light is changed to be in the second state where the current vehicle is not allowed to cross the intersection, and when there is the vehicle behind a to-be-measured vehicle (i.e., the current vehicle), acquire the first prediction result indicating whether or not the current vehicle is capable of crossing the intersection in accordance with the first time period t1, the first distance between the current vehicle and the intersection where the traffic light is located, and the detection result of the vehicle behind the current vehicle. As a result, it is able to facilitate a driver to select an appropriate speed, so as to cross the intersection and meanwhile increase the chance that the vehicle behind the current vehicle crosses the intersection before the traffic light is changed to be in the second state, thereby to improve the traffic efficiency and effectively prevent the occurrence of rear-end collision.

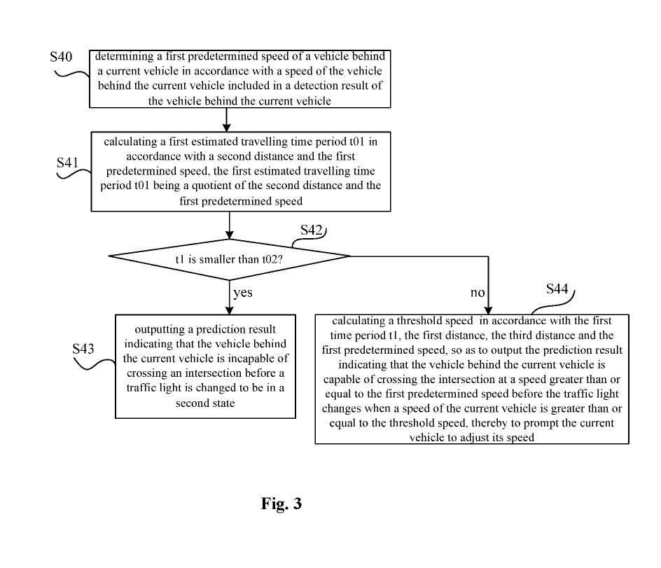

To be specific, as shown in FIG. 3, the step of acquiring and outputting the first prediction result indicating whether or not the current vehicle is capable of crossing the intersection in accordance with the first time period t1, the first distance and the detection result of the vehicle behind the current vehicle includes: Step S40 of determining a first predetermined speed in accordance with the speed of the vehicle behind the current vehicle included in the detection result of the vehicle behind the current vehicle; Step S41 of calculating a first estimated travelling time period t01 in accordance with the second distance and the first predetermined speed, the first estimated travelling time period t01 is the second distance divided by the first predetermined speed; Step S42 of comparing the first time period t1 with the first estimated travelling time period t01, when the first time period t1 is smaller than the first estimated travelling time period t01, proceeding to Step S43, and when the first time period t1 is greater than or equal to the first estimated travelling time period t01, proceeding to Step S44; Step S43 of outputting the prediction result indicating that the vehicle behind the current vehicle is incapable of crossing the intersection before the traffic light is changed to be in the second state, and terminating the output of the prediction result; Step S44 of calculating a threshold speed of the current vehicle in accordance with the first time period t1, the first distance, the third distance and the first predetermined speed, so as to output the prediction result indicating that the vehicle behind the current vehicle is capable of crossing the intersection at a speed greater than or equal to the first predetermined speed before the traffic light changes when a speed of the current vehicle is greater than or equal to the threshold speed, thereby to prompt the current vehicle to adjust its speed (e.g., accelerate).

According to the vehicle travelling prediction method in the embodiments of the present disclosure, the speed of the vehicle behind the current vehicle may be detected using a camera arranged at a rear end of the current vehicle and a radio frequency mode, and the first estimated travelling time period may be calculated in accordance with its speed and the distance between it and the intersection. When the vehicle behind the current vehicle is capable of crossing the intersection at a speed upper limit before the traffic light is changed to be in the second state, a smallest speed of the current vehicle sufficient to cross the intersection (i.e., the threshold speed) may be calculated on the premise that no rear-end collision occurs and the vehicle behind the current vehicle is capable of crossing the intersection before the traffic light is changed to be in the second state, and then a prompt may be sent to the driver of the current vehicle. When the driver of the current vehicle selects a speed greater than or equal to the smallest speed, it is able to facilitate the vehicle behind the current vehicle to cross the intersection, thereby to improve the traffic efficiency. It should be appreciated that, the vehicle travelling prediction method may be applied to a smart vehicle (including an automatic driving function and an assistant driving function).

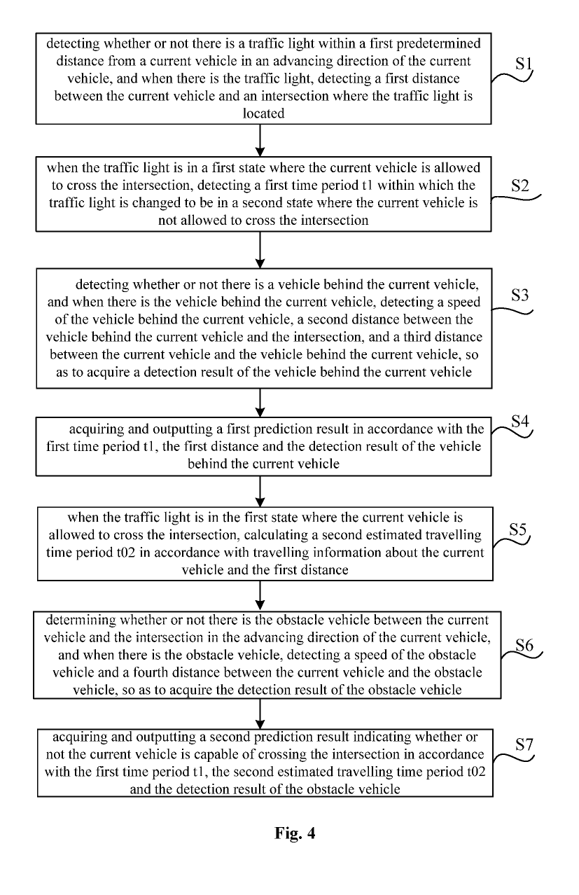

As shown in FIG. 4, the vehicle travelling prediction method further includes: Step S5 of, when the traffic light is in the first state where the current vehicle is allowed to cross the intersection, calculating a second estimated travelling time period t02 in accordance with travelling information about the current vehicle and the first distance; Step S6 of determining whether or not there is an obstacle vehicle between the current vehicle and the intersection in the advancing direction of the current vehicle, and when there is the obstacle vehicle, detecting a speed of the obstacle vehicle and a fourth distance between the current vehicle and the obstacle vehicle, so as to acquire the detection result of the obstacle vehicle; and Step S7 of acquiring and outputting a second prediction result indicating whether or not the current vehicle is capable of crossing the intersection in accordance with the first time period t1, the second estimated travelling time period t02 and the detection result of the obstacle vehicle.

According to the vehicle travelling prediction method in the embodiments of the present disclosure, through detecting the traffic light and determining the state of the traffic light, it is able to, when the traffic light is in the state where the current vehicle is allowed to cross the intersection, determine whether or not the current vehicle is capable of crossing the intersection before the traffic light is changed to be in the second state in accordance with the time period within which the traffic light is changed to be in the second state where the current vehicle is not allowed to cross the intersection, the first estimated travelling time period and the detection result of the obstacle vehicle, so as to output the corresponding second prediction result, thereby to facilitate the driver to select an appropriate driving way in accordance with the second prediction result. In addition, when there is the vehicle behind the current vehicle and the speed of the current vehicle is greater than or equal to the threshold speed, it is able to acquire, in accordance with the time period within which the traffic light is changed to be in the second state where the current vehicle is not allowed to cross the intersection, the first distance between the current vehicle and the intersection and the detection result of the vehicle behind the current vehicle, the first prediction result indicating that the vehicle behind the current vehicle is capable of crossing the intersection at a speed greater than or equal to the first predetermined speed before the traffic light is changed to be in the second state. As a result, it is able for the driver to select an appropriate driving speed, so as to cross the intersection and meanwhile increase the chance of the vehicle behind the current vehicle crossing the intersection before the traffic light is changed to be in the second state, thereby to improve the traffic efficiency.

To be specific, the second predetermined speed may be a speed upper limit or a current speed of the current vehicle.

In actual use, a market-available on-board system may be provided with a camera, and a distance from a traffic light, e.g., 300 m, may be preset by a user. In other words, when the distance between the current vehicle and the traffic light is 300 m, the camera may acquire the time period within which the state of the traffic light is to be changed, and input it to a central processor in real time. Then, the prediction result may be calculated in accordance with the distance, the speed and a current road condition.

Counting down information of the traffic light may be acquired through catching the traffic light signal by the camera in real time and identifying image information about the traffic light by a graph identification module. In future, a visible light communication technology may be applied to the traffic light, and real-time information about the traffic light may be represented by a code stream formed by invisible high-frequency blinking of the traffic light. A code stream formed by the visible light may still be received by the camera. Then, the image containing the information about the code streams may be decoded, so as to acquire instantaneous information of the traffic light. The counting down of the traffic light is regular, so it is unnecessary for the camera to catch the traffic light signal all the time. However, any tiny difference in the time may lead to the false determination of the travelling state of the vehicles in proximity to the traffic light. In order to determine the state of the traffic light, it is necessary to catch the information about the traffic light at a frequency of one or more times per second. Further, after the acquisition of the information about the traffic light, the time for identifying the image or decoding also needs to be taken into consideration in the subsequent calculation procedure.

For example, when a green light is about to be changed to a red light, the calculation may be performed in accordance with the information about the traffic light and an allowable maximum speed (i.e., the speed upper limit). When there is no obstacle vehicle ahead of the current vehicle and the time for the current vehicle to run at the speed upper limit over the distance between the current vehicle and the intersection is greater than the remaining time for the green light (or the traffic light is changed to be the red light when the current vehicle arrives at the intersection), it is able to prompt the driver to slow down appropriately and calculate a speed in a fuel-efficient manner. When the time for the current vehicle to run at the speed upper limit over the distance between the current vehicle and the intersection is smaller than the remaining time for the green light, it means that the current vehicle is likely capable of crossing the intersection before the traffic light is changed to the red light. At this time, it is necessary to perform the next calculation procedure in accordance with the road condition, i.e., acquire in real time, through a continuous-wave radar, the speed of the vehicle ahead of the current vehicle in a same lane and a distance between the current vehicle and the vehicle ahead of the current vehicle. To be specific, when the vehicle ahead of the current vehicle also runs at the speed upper limit, it is equivalent to the case where there is no obstacle vehicle. When the vehicle ahead of the current vehicle runs at a speed smaller than the speed upper limit, it is necessary to calculate a time period t11 within which the current vehicle is capable of getting, at the speed upper limit, close to the vehicle ahead of the current vehicle and keeping a safe distance therebetween. When t11 is greater than the remaining time for the green light, it means that the current vehicle is capable of crossing the intersection at the speed upper limit without the occurrence of rear-end collision with the vehicle ahead of the current vehicle. When t11 is smaller than the remaining time for the green light and the current vehicle is incapable of changing its lane, the speed of the current vehicle may be limited by the speed of the vehicle ahead thereof. In order to prevent the occurrence of rear-end collision and cross the intersection as soon as possible, the current vehicle needs to run at a speed same to the vehicle ahead the current vehicle, and at this time, it is necessary to calculate a time period t12 within which the current vehicle is capable of crossing the intersection at the speed same to the vehicle ahead the current vehicle. When t11+t12 is smaller than the remaining time for the green light, it is able to perform the calculation in accordance with t11, t12, the speed upper limit and the speed of the vehicle ahead of the current vehicle, and notify the driver of a maximum speed of the current vehicle and a minimum travelling time period. When t11+t12 is greater than the remaining time for the green light, it is able to notify the driver that the current vehicle is incapable of crossing the intersection before the traffic light is changed. The entire calculation procedure is performed by the central processor and the information is fed back to the driver in real time.

When the red light is about to be changed to the green light, the driver may likely stop the vehicle for any other activities such as drinking water, and sometimes the driver may not notice the change of the traffic light and thereby may not start the vehicle in time. At this time, the driver may set in advance the time for prompting that the red light has been changed to the green light, e.g., a prompt may be sent 3 seconds before the red light has been changed to the green light.

In addition, during the traffic jam, a safe distance and a maximum distance between the current vehicle and the vehicle ahead thereof may be calculated and set in advance through the central processor in accordance with a response speed of the driver. For example, when the distance between the current vehicle and the vehicle ahead thereof is smaller than the safe distance, the driver may be prompted to slow down, and when the distance therebetween is greater than the maximum distance, the driver may be prompted to accelerate appropriately. In this way, it is able to effectively prevent the occurrence of rear-end collision with the vehicle ahead of the current vehicle due to the distraction in the long-term traffic jam.

In addition, according to the vehicle travelling prediction method in the embodiments of the present disclosure, the speed of the vehicle behind the current vehicle may be detected using a camera arranged at a rear end of the current vehicle and a radio frequency mode, and calculation may be implemented in accordance with its speed and the distance between it and the intersection. When the vehicle behind the current vehicle is capable of crossing the intersection at a speed upper limit before the traffic light is changed to be in the second state, a smallest speed of the current vehicle sufficient to cross the intersection may be calculated on the premise that no rear-end collision occurs and the vehicle behind the current vehicle is capable of crossing the intersection before the traffic light is changed to be in the second state, and then a prompt may be sent to the driver of the current vehicle. When the drivers selects a speed greater than or equal to the smallest speed, it is able to facilitate the vehicle behind the current vehicle to cross the intersection, thereby to improve the traffic efficiency.

To be specific, the step of calculating the second estimated travelling time period t02 in accordance with the travelling information about the current vehicle and the first distance includes: determining a second predetermined speed of the current vehicle in accordance with speed information included in the travelling information about the current vehicle; and calculating the second estimated travelling time period t02 in accordance with the first distance and the second predetermined speed, the second estimated travelling time period t02 is first distance divided by the second predetermined speed. The second predetermined speed may be the speed upper limit or the current speed of the current vehicle.

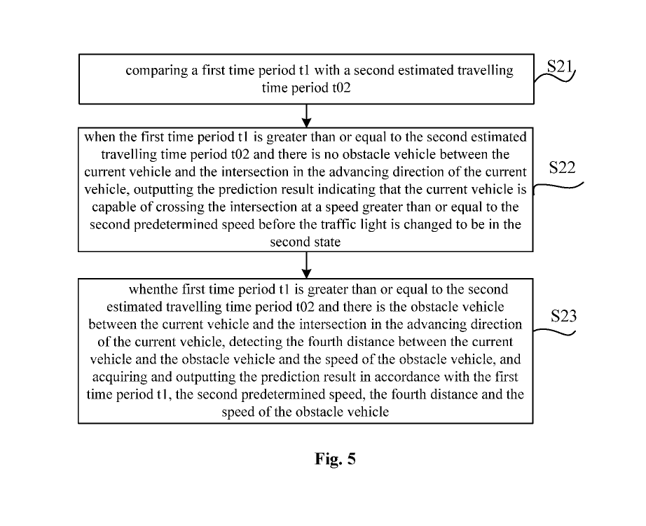

To be specific, as shown in FIG. 5, the step of acquiring and outputting the second prediction result indicating whether or not the current vehicle is capable of crossing the intersection in accordance with the first time period t1, the second estimated travelling time period t02 and the detection result of the obstacle vehicle includes: Step S21 of comparing the first time period t1 with the second estimated travelling time period t02; Step S22 of, when the first time period t1 is greater than or equal to the second estimated travelling time period t02 and there is no obstacle vehicle between the current vehicle and the intersection in the advancing direction of the current vehicle, outputting the prediction result indicating that the current vehicle is capable of crossing the intersection at a speed greater than or equal to the second predetermined speed before the traffic light is changed to be in the second state (i.e., before the green light is changed to the red light) (i.e., when t1 is greater than or equal to t02 and there is no obstacle vehicle between the current vehicle and the intersection, the current vehicle is capable of crossing the intersection before the traffic light is changed); and Step S23 of, when the first time period t1 is greater than or equal to the second estimated travelling time period t02 and there is the obstacle vehicle between the current vehicle and the intersection in the advancing direction of the current vehicle, detecting the fourth distance between the current vehicle and the obstacle vehicle and the speed of the obstacle vehicle, and acquiring and outputting the prediction result in accordance with the first time period t1, the second predetermined speed, the fourth distance and the speed of the obstacle vehicle (i.e., when t1 is greater than or equal to t02 and there is the obstacle vehicle between the current vehicle and the intersection, it is necessary to acquire, in accordance with t1, the second predetermined speed, the fourth distance and the speed of the obstacle vehicle, the prediction result indicating whether or not the current vehicle is capable of crossing the intersection before the traffic light is changed, and an algorithm for acquiring the prediction result will be described hereinafter).

To be specific, the vehicle travelling prediction method further includes, when the first time period t1 is greater than or equal to the second estimated travelling time period t02 and there is no obstacle vehicle between the current vehicle and the intersection in the advancing direction of the current vehicle, outputting information indicating that there is no obstacle vehicle in front of the current vehicle and the current vehicle is capable of being accelerated so as to facilitate the vehicle behind the current vehicle to cross the intersection. In other words, when there is no obstacle vehicle between the current vehicle and the intersection and the current vehicle is capable of crossing the intersection before the traffic light is changed, it is able to output the information indicating that the current vehicle is capable of being accelerated so as to facilitate the vehicle behind the current vehicle to cross the intersection, thereby to improve the traffic efficiency.

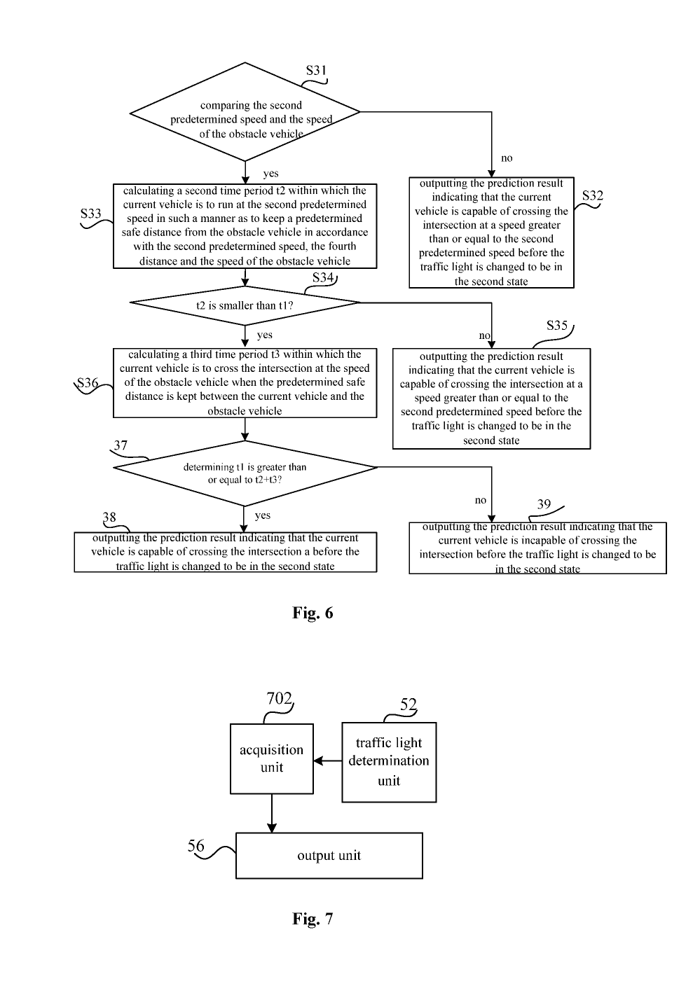

To be specific, as shown in FIG. 6, the step of acquiring and outputting the second prediction result indicating that the current vehicle is capable of crossing the intersection in accordance with the first time period t1, the second predetermined speed, the fourth distance and the speed of the obstacle vehicle includes: Step S31 of comparing the second predetermined speed and the speed of the obstacle vehicle, when the second predetermined speed is smaller than or equal to the speed of the obstacle vehicle, proceeding to Step S32, and when the second predetermined speed is greater than the speed of the obstacle vehicle, proceeding to Step S33; Step S32 of outputting the prediction result indicating that the current vehicle is capable of crossing the intersection at a speed greater than or equal to the second predetermined speed before the traffic light is changed to be in the second state, and terminating the output of the prediction result; Step S33 of calculating a second time period t2 within which the current vehicle is to run at the second predetermined speed in such a manner as to keep a predetermined safe distance from the obstacle vehicle in accordance with the second predetermined speed, the fourth distance and the speed of the obstacle vehicle; Step S34 of comparing the second time period t2 with the first time period t1, when t2 is greater than or equal to t1, proceeding to Step S35, and when t2 is smaller than t1, proceeding to Step S36; Step S35 of outputting the prediction result indicating that the current vehicle is capable of crossing the intersection at a speed greater than or equal to the second predetermined speed before the traffic light is changed to be in the second state, and terminating the output of the prediction result; Step S36 of calculating a third time period t3 within which the current vehicle is to cross the intersection at the speed of the obstacle vehicle when the predetermined safe distance is kept between the current vehicle and the obstacle vehicle; Step S37 of comparing t1 with t2+t3, when t1 is greater than or equal to t2+t3, proceeding to Step S38, and when t1 is smaller than t2+t3, proceeding to Step S39; Step S38 of outputting the prediction result indicating that the current vehicle is capable of crossing the intersection before the traffic light is changed to be in the second state, and terminating the output of the prediction result; and Step S39 of outputting the prediction result indicating that the current vehicle is incapable of crossing the intersection before the traffic light is changed to be in the second state, and terminating the output of the prediction result.

FIG. 6 shows the calculation of the second prediction result when a time period for the change of the traffic light (i.e., the first time period t1) is greater than or equal to the second estimated travelling time period t02 and there is the obstacle vehicle ahead of the current vehicle. At first, the speed of the obstacle vehicle needs to be compared with the second predetermined speed. When the second predetermined speed is smaller than or equal to the speed of the obstacle vehicle, the prediction result indicating that the current vehicle is capable of crossing the intersection before the traffic light is changed may be outputted. When the second predetermined speed is greater than the speed of the obstacle vehicle, it is necessary to calculate, in accordance with the fourth distance, the second time period t2 within which the current vehicle is capable of getting close to the obstacle vehicle in the case of no rear-end collision (i.e., the distance between the two vehicles is not smaller than the safe distance), and compare t1 with t2. When t2 is greater than or equal to t1, it means that the current vehicle is capable of crossing the intersection at the second predetermined speed before the traffic light is changed without the occurrence of rear-end collision, and the corresponding prediction result may be outputted. When t2 is smaller than t1, it is necessary to further calculate the third time period t3 within which the current vehicle is capable of crossing the intersection at the speed of the obstacle vehicle, and then compare t1 with t2+t3. When t1 is greater than or equal to t2+t3, it means that the current vehicle is capable of crossing the intersection before the traffic light is changed, and the corresponding prediction result may be outputted. When t1 is smaller than t2+t3, it means that the current vehicle is incapable of crossing the intersection before the traffic light is changed, and the corresponding prediction result may be outputted.

To be specific, the vehicle travelling prediction method further includes, when t1 is greater than or equal to t2+t3, outputting information indicating that there is the obstacle vehicle in front of the current vehicle but the current vehicle is capable of being accelerated so as to facilitate the vehicle behind the current vehicle to cross the intersection before the traffic light is changed to be in the second state. In other words, when there is the obstacle vehicle ahead of the current vehicle but the current vehicle is still capable of crossing the intersection before the traffic light is changed, it is able to prompt the current vehicle to be accelerated, so as to increase the chance of the vehicle behind the current vehicle crossing the intersection.

When t1 is smaller than t2+t3, the vehicle travelling prediction method further includes outputting information indicating that there is the obstacle vehicle in front of the current vehicle and the current vehicle is incapable of being accelerated so as to facilitate the vehicle behind the current vehicle to cross the intersection before the traffic light is changed to be in the second state. In other words, when there is the obstacle vehicle ahead of the current vehicle and the current vehicle is incapable of crossing the intersection before the traffic light is changed, it is able to prompt the current vehicle not to be accelerated.

In a possible embodiment of the present disclosure, the step of detecting the fourth distance between the current vehicle and the obstacle vehicle and the speed of the obstacle vehicle may include detecting the fourth distance between the current vehicle and the obstacle vehicle and the speed of the obstacle vehicle through a frequency-modulated continuous-wave radar.

In actual use, the fourth distance between the current vehicle and the obstacle vehicle and the speed of the obstacle vehicle may be detected through the distance measurement and speed measurement functions of frequency-modulated continuous-wave radar. A basic principle of the frequency-modulated continuous-wave radar will be described as follows. When a continuous frequency-modulated radar signal from the frequency-modulated continuous-wave radar reaches a target (i.e., the obstacle vehicle), a delayed backward wave may be generated. The backward wave may then be analyzed and processed on the basis of a Doppler's principle, so as to acquire information about a relative speed and a distance between the two vehicles.

To be specific, the frequency-modulated continuous-wave radar may also be used to detect whether or not there is the vehicle behind the current vehicle, the distance between the current vehicle and the vehicle behind the current vehicle, and the speed of the vehicle behind the current vehicle.

To be specific, the vehicle travelling prediction method further includes, when the first time period t1 is smaller than the second estimated travelling time period t02, outputting the prediction result indicating that the current vehicle is incapable of crossing the intersection before the traffic light is changed to be in the second state. Obviously, if the time period within which the current vehicle is capable of arriving at the intersection at the first predetermined speed (i.e., the second estimated travelling time period t02) is greater than the time period for the change of the traffic light (i.e., the first time period t1), it means that the current vehicle is incapable of crossing the intersection before the traffic light is changed (from the green light to the red light).

To be specific, the vehicle travelling prediction method further includes, when the traffic light is in the second state where the current vehicle is not allowed to cross the intersection, detecting and outputting a time period t4 within which the traffic light is changed to be in the first state where the current vehicle is allowed to cross the intersection. In this way, it is able for the driver to accurately acquire the time period for the change of the traffic light, thereby to prevent the waste of time and improve the traffic efficiency.

As mentioned above, the traffic light is changed between the red light and the green light, and in actual use, the traffic light may further include a yellow light.

To be specific, the vehicle travelling prediction method further includes detecting whether or not there is a vehicle of a specific type within a second predetermined distance from the current vehicle, and when there is the vehicle of the specific type, detecting travelling information about the vehicle of the specific type and outputting a corresponding prompt.

To be specific, the step of detecting the travelling information about the vehicle of the specific type and outputting the corresponding prompt includes: when there is the vehicle of the specific type, determining whether the vehicle of the specific type is ahead of or behind the current vehicle; when the vehicle of the specific type is behind the current vehicle, outputting the prompt indicating that the current vehicle is capable of changing its lane so as to avoid the vehicle of the specific type; and when the vehicle of the specific type is ahead of the current vehicle, detecting a fifth distance between the current vehicle and the vehicle of the specific type, determining whether or not the current vehicle is capable of crossing the intersection at a speed greater than or equal to the second predetermined speed in accordance with the second predetermined speed, the travelling information about the vehicle of the specific type, the first distance and the fifth distance, and outputting the corresponding prediction result.

In actual use, the on-board system may include a sound recognition module and a light recognition module. When there is the vehicle of the specific type (e.g., an ambulance car or a police car which needs to drive fast) ahead of or behind the current vehicle, the sound recognition module and the light recognition module may acquire its specific light signal and sound signal, send a prompt to the driver and start to use a specific calculation method. For example, when there is the vehicle of the specific type ahead of the current vehicle, it is able to determine whether or not the current vehicle is capable of crossing the intersection at the speed upper limit or the current speed. When there is the vehicle of the specific type behind the current vehicle, it is able to prompt the current vehicle to change its lane in time or run in such a manner as not to affect the travelling of the vehicle of the specific type, and meanwhile plan an appropriate path for the current vehicle in time.

To be specific, the second predetermined speed is the speed upper limit, the current speed of the current vehicle or an average speed of the current vehicle, and the first predetermined speed is the speed upper limit, the current speed of the vehicle behind the current vehicle or an average speed of the vehicle behind the current vehicle.

Referring to FIG. 7, the present disclosure further provides in some embodiments a vehicle travelling prediction device, which includes a traffic light determination unit 52, an acquisition unit 702 and an output unit 56. The traffic light determination unit 52 is configured to determine a state of a traffic light. The acquisition unit 702 is configured to acquire a first distance between a current vehicle and an intersection in an advancing direction of the current vehicle where the traffic light is located, and when the traffic light is in a first state where the current vehicle is allowed to cross the intersection, acquire a first time period t1 within which the traffic light is changed to be in a second state where the current vehicle is not allowed to cross the intersection and acquire a detection result of a vehicle in a same lane. The detection result of the vehicle in the same lane includes a detection result of a vehicle behind the current vehicle and/or a detection result of an obstacle vehicle. The output unit 56 is configured to output a prediction result indicating whether or not the current vehicle is capable of crossing the intersection in accordance with the first time period t1, the first distance and the detection result of the vehicle in the same lane.

In a possible embodiment of the present disclosure, as shown in FIG. 8, the vehicle travelling prediction device may further include a traffic light detection unit, and the acquisition unit may include a first distance measurement unit, a first detection unit and a first calculation unit. The traffic light detection unit 51 is configured to detect whether or not there is the traffic light within a first predetermined distance from the current vehicle in the advancing direction of the current vehicle, and when there is the traffic light, output a first control signal. The traffic light determination unit 52 is connected to the traffic light detection unit 51 and further configured to, upon the receipt of the first control signal, determine the state of the traffic light, and when the traffic light is in the first state where the current vehicle is allowed to cross the intersection, detect the first time period t1 within which the traffic light is changed to be in the second state where the current vehicle is not allowed to cross the intersection. The first distance measurement unit 53 is connected to the traffic light detection unit 51 and configured to, upon the receipt of the first control signal, detect the first distance between the current vehicle and the intersection where the traffic light is located. The first detection unit 54 is configured to detect whether or not there is the vehicle behind the current vehicle, and when there is the vehicle behind the current vehicle, detect a speed of the vehicle behind the current vehicle, a second distance between the vehicle behind the current vehicle and the intersection, and a third distance between the current vehicle and the vehicle behind the current vehicle, so as to acquire the detection result of the vehicle behind the current vehicle. The first calculation unit 55 is connected to the traffic light determination unit 52, the first distance measurement unit 53 and the first detection unit 54, and configured to acquire a first prediction result indicating whether or not the current vehicle is capable of crossing the intersection in accordance with the first time period t1, the first distance and the detection result of the vehicle behind the current vehicle. The output unit 56 is connected to the first calculation unit 55 and further configured to output the first prediction result.

According to the vehicle travelling prediction device in the embodiments of the present disclosure, through detecting the traffic light by the traffic light detection unit 51 and determining the state of the traffic light by the traffic light determination unit 52, it is able to, when the traffic light is in the state where the current vehicle is allowed to cross the intersection, detect the first time period t1 within which the traffic light is changed to be in the second state where the current vehicle is not allowed to cross the intersection, and when there is the vehicle behind the current vehicle, acquire the first prediction result indicating whether or not the current vehicle is capable of crossing the intersection in accordance with the first time period t1, the first distance between the current vehicle and the intersection where the traffic light is located, and the detection result of the vehicle behind the current vehicle. As a result, it is able to facilitate a driver to select an appropriate speed, so as to cross the intersection and meanwhile facilitate the vehicle behind the current vehicle to cross the intersection before the traffic light is changed to be in the second state, thereby to improve the traffic efficiency.

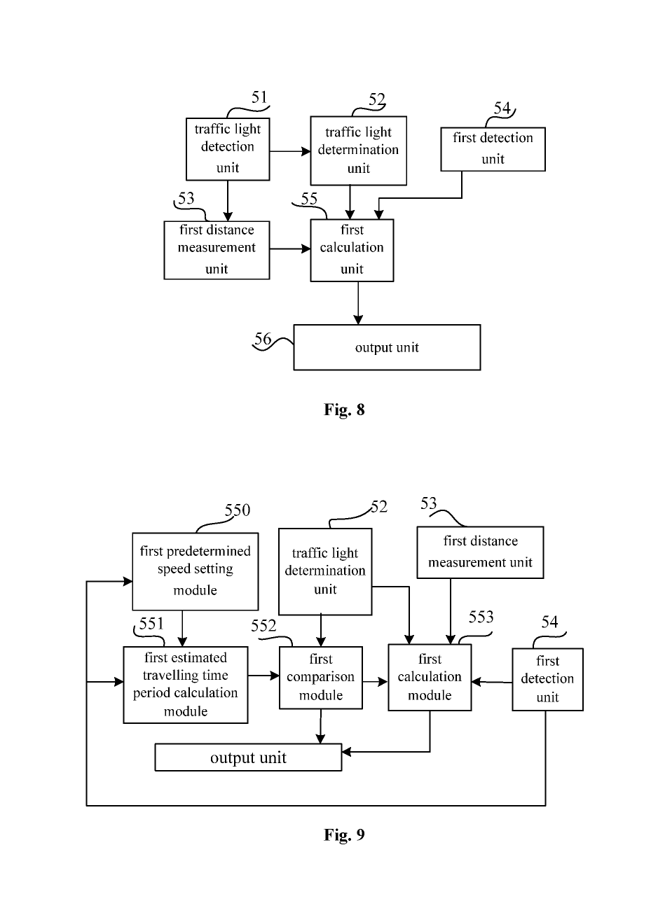

As shown in FIG. 9, the first calculation unit 55 may include a first predetermined speed setting module 550, a first estimated travelling time period calculation module 551, a first comparison module 552 and a first calculation module 553. The first predetermined speed setting module 550 is connected to the first detection unit 54 and configured to set a first predetermined speed of the vehicle behind the current vehicle in accordance with the speed of the vehicle behind the current vehicle included in the detection result of the vehicle behind the current vehicle. The first estimated travelling time period calculation module 551 is connected to the first detection unit 54 and the first predetermined speed setting module 550, and configured to calculate a first estimated travelling time period t01 in accordance with the second distance and the first predetermined speed, and the first estimated travelling time period t01 is a the second distance divided by the first predetermined speed. The first comparison module 552 is connected to the first estimated travelling time period calculation module 551 and the traffic light state determination module 52, and configured to compare the first time period t1 with the first estimated travelling time period t01, when the first time period t1 is smaller than the first estimated travelling time period t01, output a twelfth control signal, and when the first time period t1 is greater than or equal to the first estimated travelling time period t01, output a thirteenth control signal. The first calculation module 553 is connected to the first comparison module 552, the traffic light determination unit 52, the first distance measurement unit 53 and the first detection unit 54, and configured to, upon the receipt of the thirteenth control signal, calculate a threshold speed of the current vehicle in accordance with the first time period t1, the first distance, the third distance and the first predetermined speed, and output a fourteenth control signal. The output unit 56 is further connected to the first comparison module 552 and the first calculation module 553, and further configured to, upon the receipt of the twelfth control signal, output the prediction result indicating that the vehicle behind the current vehicle is incapable of crossing the intersection before the traffic light is changed to be in the second state, and upon the receipt of the fourteenth control signal, output the prediction result indicating that the vehicle behind the current vehicle is capable of crossing the intersection at a speed greater than or equal to the first predetermined speed before the traffic light changes when a speed of the current vehicle is greater than or equal to the threshold speed, thereby to prompt the current vehicle to adjust its speed (e.g., to be accelerated).

According to the vehicle travelling prediction device in the embodiments of the present disclosure, the speed of the vehicle behind the current vehicle may be detected using a camera arranged at a rear end of the current vehicle and a radio frequency mode, and the first estimated travelling time period may be calculated in accordance with its speed and the distance between it and the intersection. When the vehicle behind the current vehicle is capable of crossing the intersection at a speed upper limit before the traffic light is changed to be in the second state, a smallest speed of the current vehicle sufficient to cross the intersection (i.e., the threshold speed) may be calculated on the premise that no rear-end collision occurs and the vehicle behind the current vehicle is capable of crossing the intersection before the traffic light is changed to be in the second state, and then a prompt may be sent to the driver of the current vehicle. When the drivers selects a speed greater than or equal to the smallest speed, it is able to facilitate the vehicle behind the current vehicle to cross the intersection, thereby to improve the traffic efficiency.

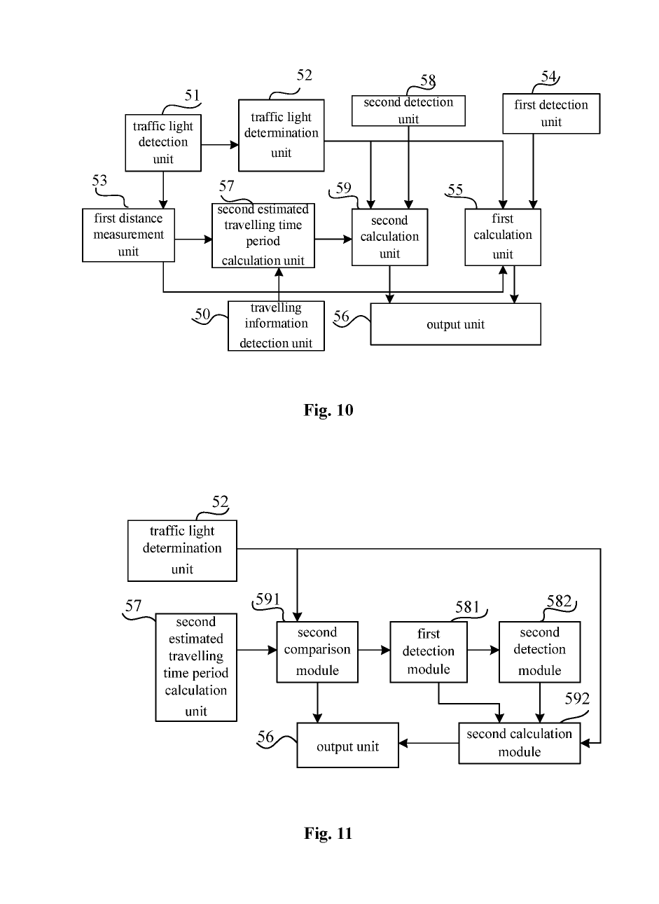

In a possible embodiment of the present disclosure, as shown in FIG. 10, the vehicle travelling prediction device includes: a travelling information detection unit 50 configured to detect travelling information about the current vehicle; a second estimated travelling time period calculation unit 57 connected to the first distance measurement unit 53 and the travelling information detection unit 50 and configured to calculate a second estimated travelling time period t02 in accordance with the travelling information about the current vehicle and the first distance; a second detection unit 58 configured to determine whether or not there is the obstacle vehicle between the current vehicle and the intersection in the advancing direction of the current vehicle, and when there is the obstacle vehicle, detect a speed of the obstacle vehicle and a fourth distance between the current vehicle and the obstacle vehicle, so as to acquire the detection result of the obstacle vehicle; and a second calculation unit 59 connected to the traffic light determination unit 52, the second estimated travelling time period calculation unit 57 and the second detection unit 58, and configured to acquire a second prediction result indicating whether or not the current vehicle is capable of crossing the intersection in accordance with the first time period t1, the second estimated travelling time period t02 and the detection result of the obstacle vehicle. The output unit 56 is further connected to the second calculation unit 59 and further configured to output the second prediction result.

According to the vehicle travelling prediction device in the embodiments of the present disclosure, through detecting the traffic light and determining the state of the traffic light, it is able to, when the traffic light is in the state where the current vehicle is allowed to cross the intersection, determine whether or not the current vehicle is capable of crossing the intersection before the traffic light is changed to be in the second state in accordance with the time period within which the traffic light is changed to be in the second state where the current vehicle is not allowed to cross the intersection, the first estimated travelling time period and the detection result of the obstacle vehicle, so as to output the corresponding second prediction result, thereby to facilitate the driver to select an appropriate speed in accordance with the second prediction result. In addition, when there is the vehicle behind the current vehicle and the speed of the current vehicle is greater than or equal to the threshold speed, it is able to acquire, in accordance with the time period within which the traffic light is changed to be in the second state where the current vehicle is not allowed to cross the intersection, the first distance between the current vehicle and the intersection and the detection result of the vehicle behind the current vehicle, the first prediction result indicating that the vehicle behind the current vehicle is capable of crossing the intersection at a speed greater than or equal to the first predetermined speed before the traffic light is changed to be in the second state. As a result, it is able for the driver to select an appropriate speed, so as to cross the intersection and meanwhile facilitate the vehicle behind the current vehicle to cross the intersection before the traffic light is changed to be in the second state, thereby to improve the traffic efficiency.

To be specific, the travelling information about the current vehicle includes speed information. The vehicle travelling prediction device further includes a second predetermined speed setting unit configured to determine a second predetermined speed in accordance with the speed information. The second estimated travelling time period calculation unit is further connected to the second predetermined speed setting unit and further configured to calculate the second estimated travelling time period t02 in accordance with the first distance and the second predetermined speed. The second estimated travelling time period t02 is the first distance divided by the second predetermined speed.

In actual use, as shown in FIG. 11, the second calculation unit 59 may include a second comparison module 591 and a second calculation module 592. The second detection unit 58 may include a first detection module 581 and a second detection module 582. The second comparison module 591 is connected to the traffic light determination unit 52 and the second estimated travelling time period calculation unit 57, and configured to compare the first time period t1 with the second estimated travelling time period t02, and when the first time period t1 is greater than or equal to the second estimated travelling time period t02, output a second control signal. The first detection module 581 is connected to the second comparison module 591 and configured to, upon the receipt of the second control signal, detect whether or not there is the obstacle vehicle between the current vehicle and the intersection in the advancing direction of the current vehicle, when there is the obstacle vehicle, output a third control signal, and when there is no obstacle vehicle, output a fourth control signal. The second detection module 582 is connected to the first detection module 581 and configured to, upon the receipt of the third control signal, detect the fourth distance between the current vehicle and the obstacle vehicle and the speed of the obstacle vehicle. The second calculation module 592 is connected to the second detection module 582 and the traffic light determination unit 52, and configured to acquire the corresponding prediction result in accordance with the first time period t1, the second predetermined speed, the fourth distance and the speed of the obstacle vehicle. The output unit 56 is further connected to the second calculation module 592 and the first detection module 581, and further configured to, upon the receipt of the fourth control signal, output the prediction result indicating that the current vehicle is capable of crossing the intersection at a speed greater than or equal to the second predetermined speed before the traffic light is changed to be in the second state, and upon the receipt of the third control signal, output the prediction result acquired by the second calculation module 592.

According to the vehicle travelling prediction device in the embodiments of the present disclosure, the second comparison module 591 may compare the first time period t1 with the second estimated travelling time period t02. When the first time period t1 is greater than or equal to the second estimated travelling time period t02 and the first detection module 581 detects that there is no obstacle vehicle between the current vehicle and the intersection in the advancing direction of the current vehicle, the output unit 56 may output the prediction result indicating that the current vehicle is capable of crossing the intersection at a speed greater than or equal to the second predetermined speed before the traffic light is changed (e.g., from the green light to the red light). When t1 is greater than or equal to t02 and the first detection module 581 detects that there is the obstacle vehicle between the current vehicle and the intersection, the second detection module 582 may detect the fourth distance between the current vehicle and the obstacle vehicle and the speed of the obstacle vehicle, and then the second calculation module 592 may acquire the prediction result indicating whether or not the current vehicle is capable of crossing the intersection before the traffic light is changed in accordance with the first time period t1, the second predetermined speed, the fourth distance between the current vehicle and the obstacle vehicle, and the speed of the obstacle vehicle.

To be specific, the output unit is further connected to the first detection module and further configured to, upon the receipt of the fourth control signal, output information indicating that there is no obstacle vehicle in front of the current vehicle and the current vehicle is capable of being accelerated so as to facilitate the vehicle behind the current vehicle to cross the intersection. In other words, when there is no obstacle vehicle between the current vehicle and the intersection and the current vehicle is capable of crossing the intersection before the traffic light is changed, the output unit may output the information indicating that the current vehicle is capable of being accelerated so as to facilitate the vehicle behind the current vehicle to cross the intersection, so as to improve the traffic efficiency.

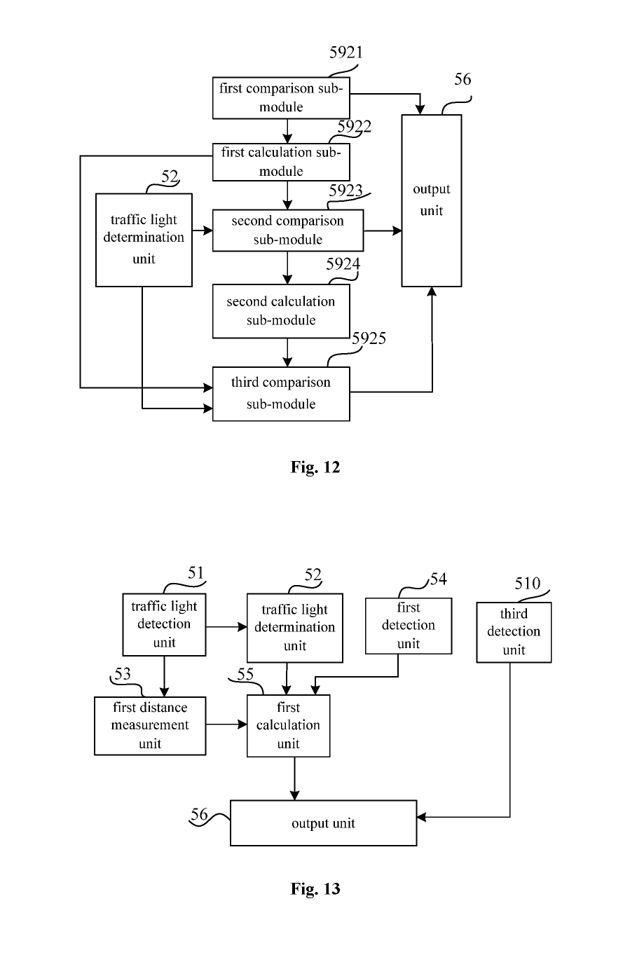

To be specific, as shown in FIG. 12, the second calculation module 592 may include: a first comparison sub-module 5921 configured to compare the second predetermined speed and the speed of the obstacle vehicle, when the second predetermined speed is smaller than or equal to the speed of the obstacle vehicle, output a fifth control signal, and when the second predetermined speed is greater than the speed of the obstacle vehicle, output a sixth control signal; a first calculation sub-module 5922 connected to the first comparison sub-module 5921 and configured to, upon the receipt of the sixth control signal, calculate a second time period t2 within which the current vehicle is to run at the second predetermined speed in such a manner as to keep a predetermined safe distance from the obstacle vehicle in accordance with the second predetermined speed, the fourth distance and the speed of the obstacle vehicle; a second comparison sub-module 5923 connected to the first calculation sub-module 5922 and the traffic light determination unit 52, and configured to compare the second time period t2 with the first time period t1, when t2 is greater than or equal to t1, output a seventh control signal, and when t2 is smaller than t1, output an eighth control signal; a second calculation sub-module 5924 connected to the second comparison sub-module 5923 and configured to, upon the receipt of the eighth control signal, a third time period t3 within which the current vehicle is to cross the intersection at the speed of the obstacle vehicle when the predetermined safe distance is kept between the current vehicle and the obstacle vehicle; and a third comparison sub-module 5925 connected to the traffic light determination unit 52, the first calculation sub-module 5922 and the second calculation sub-module 5924, and configured to compare t1 with t2+t3, when t1 is greater than or equal to t2+t3, output a ninth control signal, and when t1 is smaller than t2+t3, output a tenth control signal. The output unit 56 is further connected to the first comparison sub-module 5921, the second comparison sub-module 5923 and the third comparison sub-module 5925, and further configured to, upon the receipt of the fifth control signal, output the prediction result indicating that the current vehicle is capable of crossing the intersection at a speed greater than or equal to the second predetermined speed before the traffic light is changed to be in the second state, upon the receipt of the seventh control signal, output the prediction result indicating that the current vehicle is capable of crossing the intersection at a speed greater than or equal to the second predetermined speed before the traffic light is changed to be in the second state, upon the receipt of the ninth control signal, output the prediction result indicating that the current vehicle is capable of crossing the intersection before the traffic light is changed to be in the second state, and upon the receipt of the tenth control signal, output the prediction result indicating that the current vehicle is incapable of crossing the intersection before the traffic light is changed to be in the second state.

FIG. 12 is a block diagram of the vehicle travelling prediction device for calculating the second prediction result when the time period for the change of the traffic light (i.e., the first time period t1) is greater than or equal to the second estimated travelling time period t02 and there is the obstacle vehicle ahead of the current vehicle. At first, the first comparison sub-module 5921 may compare the speed of the obstacle vehicle with the second predetermined speed. When the second predetermined speed is smaller than or equal to the speed of the obstacle vehicle, the output unit 56 may output the prediction result indicating that the current vehicle is capable of crossing the intersection before the traffic light is changed. When the second predetermined speed is greater than the speed of the obstacle vehicle, the first calculation sub-module 5922 may calculate the second time period t2 within which the current vehicle is capable of getting close to the obstacle vehicle without the risk of rear-end collision (i.e., keeping the safe distance between the two vehicles) in accordance with the second predetermined speed, the speed of the obstacle vehicle and the fourth distance. Then, the second comparison sub-module 5923 may compare t1 with t2. When t2 is greater than or equal to t1, it means that the current vehicle is capable of crossing the intersection at the second predetermined speed before the traffic light is changed without the risk of rear-end collision with the obstacle vehicle, and the output unit 56 may output the corresponding prediction result. When t2 is smaller than t1, the second calculation sub-module 5924 may further calculate the third time period t3 within which the current vehicle is capable of further crossing the intersection at the speed of the obstacle vehicle after the current vehicle is getting close to the obstacle vehicle without the risk of rear-end collision. Next, the third comparison sub-module 5925 may compare t1 with t2+t3. When t1 is greater than t2+t3, it means that the current vehicle is capable of crossing the intersection before the traffic light is changed, and the output unit 56 may output the corresponding prediction result. When t1 is smaller than t2+t3, it means that the current vehicle is incapable of crossing the intersection before the traffic light is changed, and the output unit 56 may output the corresponding prediction result.

To be specific, the output unit is further connected to the third comparison sub-module and further configured to, upon the receipt of the ninth control signal, output information indicating that there is the obstacle vehicle in front of the current vehicle but the current vehicle is capable of being accelerated so as to facilitate the vehicle behind the current vehicle to cross the intersection before the traffic light is changed to be in the second state. In other words, when there is the obstacle vehicle but the current vehicle is still capable of crossing the intersection before the traffic light is changed, it is able to prompt the current vehicle to be accelerated so as to facilitate the vehicle behind the current vehicle to cross the intersection. The output unit is further configured to, upon the receipt of the tenth control signal, output information indicating that there is the obstacle vehicle in front of the current vehicle and the current vehicle is incapable of being accelerated before the traffic light is changed to be in the second state. In other words, when there is the obstacle vehicle and the current vehicle is incapable of crossing the intersection before the traffic light is changed, it is able to prompt the current vehicle not necessary to change its speed to facilitate the vehicle behind the current vehicle crossing the intersection.

In actual use, the second detection module may be configured to detect the fourth distance between the current vehicle and the obstacle vehicle and the speed of the obstacle vehicle through a frequency-modulated continuous-wave radar.

To be specific, the second comparison module is further configured to, when the first time period t1 is smaller than the second estimated travelling time period t02, output an eleventh control signal. The output unit is further connected to the second comparison module and further configured to, upon the receipt of the eleventh control signal, output the prediction result indicating that the current vehicle is incapable of crossing the intersection before the traffic light is changed to be in the second state.

To be specific, the traffic light determination unit is further configured to, when the traffic light is in the second state where the current vehicle is not allowed to cross the intersection, detect a time period t4 within which the traffic light is changed to be in the first state where the current vehicle is allowed to cross the intersection. The output unit is further connected to the traffic light determination unit and further configured to output the fourth time period t4.

To be specific, as shown in FIG. 13, the vehicle travelling prediction device further includes a third detection unit 510 configured to detect whether or not there is a vehicle of a specific type within a second predetermined distance from the current vehicle, and when there is the vehicle of the specific type, detect travelling information about the vehicle of the specific type and output a fifteenth control signal. The output unit 56 is further connected to the third detection unit 510 and further configured to, upon the receipt of the fifteenth control signal, output a prompt indicating that there is the vehicle of the specific type.

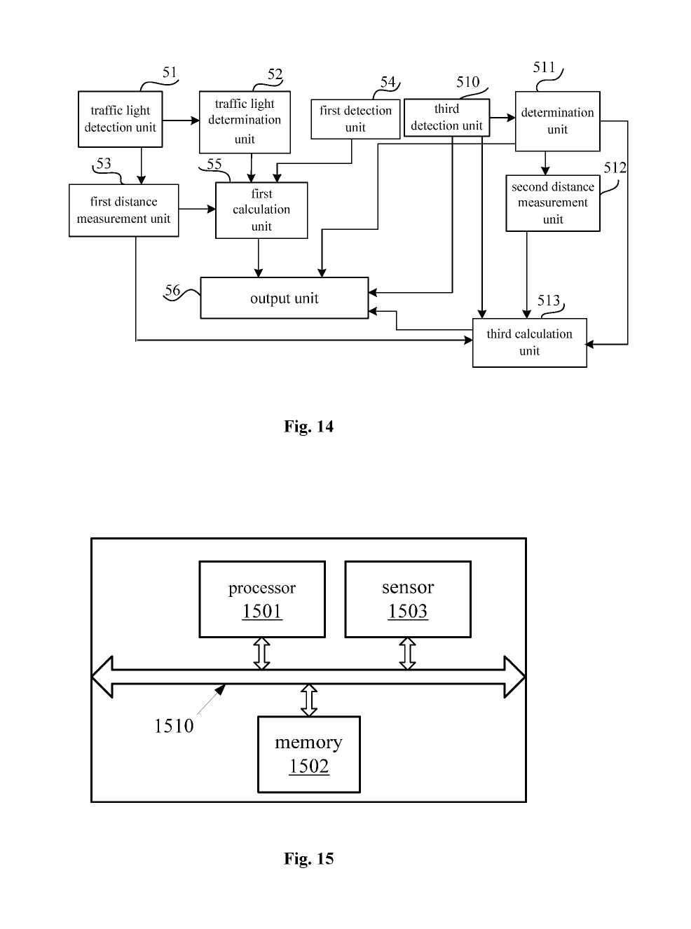

To be specific, as shown in FIG. 14, the vehicle travelling prediction device further includes: a determination unit 511 connected to the third detection unit 510, and configured to, upon the receipt of the fifteenth control signal, determine whether the vehicle of the specific type is ahead of or behind the current vehicle, when the vehicle of the specific type is behind the current vehicle, output a sixteenth control signal, and when the vehicle of the specific type is ahead of the current vehicle, output a seventeenth control signal; a second distance measurement unit 512 connected to the determination unit 511 and configured to, upon the receipt of the seventeenth control signal, detect a fifth distance between the current vehicle and the vehicle of the specific type; and a third calculation unit 513 connected to the third detection unit 510, the first distance measurement unit 53, the determination unit 511 and the second distance measurement unit 512, and configured to, upon the receipt of the seventeenth control signal, determine whether or not the current vehicle is capable of crossing the intersection at a speed greater than or equal to the second predetermined speed in accordance with the second predetermined speed, the travelling information about the vehicle of the specific type, the first distance and the fifth distance, and output an eighteenth control signal. The output unit 56 is further connected to the determination unit 511 and the third calculation unit 513, and further configured to, upon the receipt of the sixteenth control signal, output the prompt indicating that the current vehicle is capable of changing its lane so as to avoid the vehicle of the specific type, and upon the receipt of the eighteenth control signal, output the corresponding prediction result.

In actual use, the vehicle travelling prediction device may include the determination unit 511 (which may, for example, include a sound recognition module and a light recognition module). When there is the vehicle of the specific type (e.g., an ambulance car or a police car which needs to drive fast) ahead of or behind the current vehicle, the sound recognition module and the light recognition module may acquire its specific light signal and source signal, send a prompt to the driver and start to use a specific calculation method. For example, when there is the vehicle of the specific type ahead of the current vehicle, it is able to determine whether or not the current vehicle is capable of crossing the intersection at the speed upper limit or the current speed. When there is the vehicle of the specific type behind the current vehicle, it is able to prompt the current vehicle to change its lane in time or run in such a manner as not to affect the travelling of the vehicle of the specific type, and meanwhile plan an appropriate path for the current vehicle in time.

To be specific, the second predetermined speed may be a speed upper limit, a current speed of the current vehicle or an average speed of the current vehicle, and the first predetermined speed may be a speed upper limit, a current speed of the vehicle behind the current vehicle or an average speed of the vehicle behind the current vehicle.

To be specific, the output unit includes a display module configured to display the prediction result and/or a sound reminding module configured to prompt via a sound the prediction result.

In actual use, the output unit may include the display module configured to display the prediction result through a screen or through projection, and the sound reminding module configured to prompt the prediction result via a voice. In addition, the output unit may also be a communication interface through which the corresponding prompt information may be transmitted to an on-board control system, and the information may be displayed through the on-board display system.

To be specific, the traffic light detection unit includes a camera unit or a position detection unit. When the traffic light detection unit includes the camera unit, the camera unit is configured to take an image so as to determine whether or not there is the signal light within the first predetermined distance from the current vehicle in the advancing direction of the current vehicle. When the traffic light detection unit includes the position detection unit, the position detection unit is configured to detect position information about the current vehicle, and compare the position information with a pre-stored traffic light position, so as to determine whether or not there is the signal light within the first predetermined distance from the current vehicle in the advancing direction of the current vehicle.

In actual use, the position detection unit may use a Global Positioning System (GPS) or a Beidou positioning system. In addition, the position detection unit may also be a communication interface through which the positioning information from the on-board control system or a mobile terminal may be received.

During the implementation, the position detection unit may determine whether or not there is the traffic light ahead of the current vehicle. When there is the traffic light, the traffic light determination unit may be started, so as to determine the current state of the traffic light and transmit the current state of the traffic light and the time period within which the traffic light is switched to a next state to the calculation unit. The time period may be pre-stored in the position detection unit. When the time period is not stored in the position detection unit, a predetermined threshold, e.g., 4 s, may be applied. The calculation unit may receive the speed information acquired by the speed detection unit and the distance between the current vehicle and the traffic light acquired by the distance measurement unit. The calculation unit may determine the prediction result in accordance with the above information, and transmit the prediction result to the driver through the display unit. The prediction result acquired by the calculation unit may include, but not limited to, a prompt indicating that the current vehicle is capable of crossing the intersection at the current speed, a prompt indicating that the current vehicle is incapable of crossing the intersection at the current speed, and a prompt indicating the speed at which the current vehicle is capable of crossing the intersection. In addition, whether or not there is the obstacle vehicle between the current vehicle and the traffic light may be further determined. When there is the obstacle vehicle, it is necessary to determine the distance between the current vehicle and the obstacle vehicle and the speed of the obstacle vehicle, and transmit the distance and the speed to the calculation unit. Then, the calculation unit may determine the prediction result in accordance with the current speed, the time period for the change of the traffic light, the distance between the current vehicle and the traffic light, and the distance between the current vehicle and the vehicle ahead of the current vehicle, and the prediction result may be prompted to the driver through the display unit.

In actual use, the speed of the current vehicle may be detected by the speed detection unit. The speed detection unit may be a detection unit capable of detecting the speed in real time, or a communication receiving port which communicates with the on-board control system so as to directly acquire the speed of the current vehicle from the on-board control system in real time.

To be specific, the third detection unit may include a sound recognition module configured to determine whether or not there is the vehicle of the specific type within the second predetermined distance from the current vehicle through a sound of a specific type and a light recognition module configured to determine whether or not there is the vehicle of the specific type within the second predetermined distance from the current vehicle through a blinking light beam of a specific type.

The present disclosure further provides in some embodiments an on-board smart system, which includes the vehicle travelling prediction device.

To be specific, the on-vehicle smart system further includes an on-board speed detection unit configured to detect a current speed of a vehicle in real time. When a second predetermined speed is the current speed of the vehicle, the on-board speed detection unit is further configured to transmit the current speed of the vehicle to the second calculation unit of the vehicle travelling prediction device. In other words, the speed of the current vehicle may be detected in real time by the on-board speed detection unit of the on-board smart system.

To be specific, the on-board smart system further includes an on-board positioning unit configured to detect a position of the vehicle in real time. When the traffic light detection unit of the vehicle travelling prediction device includes the position detection unit, the position detection unit is connected to the on-board positioning unit and configured to receive the position of the vehicle from the on-board positioning unit. In other words, when the traffic light detection unit of the vehicle travelling prediction device includes the position detection unit, the position detection unit may detect the position of the current vehicle in real time through the on-board positioning unit.

To be specific, the on-board smart system further includes an on-board display unit. When the output unit of the vehicle travelling prediction device includes the display module, the display module is configured to output the prediction result to the on-board display unit, so that the on-board display unit displays the prediction result. In other words, the output unit may display the prediction result through the on-board display unit of the on-board smart system.

The steps of the vehicle travelling prediction method may be implemented by the vehicle travelling prediction device in FIG. 15. The vehicle travelling prediction device includes a processor 1501, a memory 1502 and at least one sensor 1503 (including a radar and a camera). The memory 1502 may include a read-only memory (ROM) or a random access memory (RAM), and it is capable of providing instructions and data to the processor 1501. A part of the memory 1502 may further include a Non-Volatile Random Access Memory (NVRAM). The processor 1501, the memory 1502 and the sensor 1503 are coupled to each other through a bus system 1510. Apart from a data bus, the bus system 1501 may further include a power source bus, a control bus and a state signal bus. However, for clarification, all the buses are marked as the bus system 1510.

The processor 1501 may be an IC having a signal processing capability. During the implementation, the above-mentioned steps may be executed by an integrated logic circuit of hardware or software in the processor 1501. The processor 1501 may be a general-purpose processor, including a Central Processing Unit (CPU), a Network Processor (NP), a Digital Signal Processor (DSP), an Application Specific Integrated Circuit (ASIC), a Field Programmable Gate Array (FPGA), or any other programmable logic element, discrete gate or transistor logic element, or discrete hardware assembly, so as to implement or execute the method, the steps and the procedures. The general-purpose processor may be a microprocessor or any other conventional processor.

In the embodiments of the present disclosure, the processor 1501 is configured to read the instructions or data stored in the memory 1502, so as to: acquire the first distance between the current vehicle and the intersection in the advancing direction of the current vehicle where the traffic light is located, and determine the state of the traffic light; when the traffic light is in the first state where the current vehicle is allowed to cross the intersection, acquire the first time period t1 within which the traffic light is changed to be in the second state where the current vehicle is not allowed to cross the intersection; acquire the detection result of the vehicle in the same lane, the detection result of the vehicle including the detection result of the vehicle behind the current vehicle and the detection result of the obstacle vehicle; and output the prediction result indicating whether or not the current vehicle is capable of crossing the intersection in accordance with the first time period t1, the first distance and the detection result of the vehicle in the same lane. In a possible embodiment of the present disclosure, the sensor 1503 may be configured to detect the relevant parameters, e.g., the distance between the vehicles, the first time period t1, the distance between each vehicle and the intersection, the speed of the vehicle behind the current vehicle or the speed of the obstacle vehicle.

According to the embodiments of the present disclosure, it is able to determine the prediction result in accordance with the travelling information about the vehicle ahead of the current vehicle and the vehicle behind the current vehicle, and facilitate the current vehicle to cross the intersection, thereby to improve the traffic efficiency and effectively prevent the occurrence of rear-end collision.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

1. A vehicle travelling prediction method, comprising steps of:
acquiring a first distance between a current vehicle and an intersection where a traffic light is located in an advancing direction of the current vehicle, and determining a state of the traffic light;
when the traffic light is in a first state where the current vehicle is allowed to cross the intersection, acquiring a first time period t1 within which the traffic light is changed to be in a second state where the current vehicle is not allowed to cross the intersection;
acquiring a detection result of a vehicle in a same lane, the detection result of the vehicle in the same lane comprising a detection result of a vehicle behind the current vehicle and/or a detection result of an obstacle vehicle; and
outputting a prediction result indicating whether or not the current vehicle is capable of crossing the intersection in accordance with the first time period t1, the first distance and the detection result of the vehicle in the same lane.

2. The vehicle travelling prediction method according to claim 1, wherein the step of acquiring the first distance between the current vehicle and the intersection where the traffic light is located in the advancing direction of the current vehicle comprises detecting whether or not there is the traffic light within a first predetermined distance from the current vehicle in the advancing direction of the current vehicle, and when there is the traffic light, detecting the first distance between the current vehicle and the intersection where the traffic light is located; and
the step of acquiring the first time period t1 within which the traffic light is changed to be in the second state where the current vehicle is not allowed to cross the intersection comprises detecting the first time period t1 within which the traffic light is changed to be in the second state.

3. The vehicle travelling prediction method according to claim 1, wherein prior to the step of acquiring the detection result of the vehicle in the same lane, the vehicle travelling prediction method further comprises detecting whether or not there is the vehicle behind the current vehicle, and when there is the vehicle behind the current vehicle, detecting a speed of the vehicle behind the current vehicle, a second distance between the vehicle behind the current vehicle and the intersection, and a third distance between the current vehicle and the vehicle behind the current vehicle, so as to acquire the detection result of the vehicle behind the current vehicle;
the step of outputting the prediction result indicating whether or not the current vehicle is capable of crossing the intersection in accordance with the first time period t1, the first distance and the detection result of the vehicle in the same lane comprises acquiring and outputting a first prediction result indicating whether or not the current vehicle is capable of crossing the intersection in accordance with the first time period t1, the first distance and the detection result of the vehicle behind the current vehicle; and
the prediction result indicating whether or not the current vehicle is capable of crossing the intersection comprises the first prediction result.

4. The vehicle travelling prediction method according to claim 3, wherein the step of acquiring and outputting the first prediction result indicating whether or not the current vehicle is capable of crossing the intersection in accordance with the first time period t1, the first distance and the detection result of the vehicle behind the current vehicle comprises:
determining a first predetermined speed in accordance with the speed of the vehicle behind the current vehicle comprised in the detection result of the vehicle behind the current vehicle;
calculating a first estimated travelling time period t01 in accordance with the second distance and the first predetermined speed, the first estimated travelling time period t01 being the second distance divided by the first predetermined speed;
comparing the first time period t1 with the first estimated travelling time period t01;
when the first time period t1 is smaller than the first estimated travelling time period t01, outputting a prediction result indicating that the vehicle behind the current vehicle is incapable of crossing the intersection before the traffic light is changed to be in the second state; and
when the first time period t1 is greater than or equal to the first estimated travelling time period t01, calculating a threshold speed in accordance with the first time period t1, the first distance, the third distance and the first predetermined speed, so as to output a prediction result indicating that the vehicle behind the current vehicle is capable of crossing the intersection at a speed greater than or equal to the first predetermined speed before the traffic light changes when a speed of the current vehicle is greater than or equal to the threshold speed, thereby to prompt the current vehicle to adjust its speed.

5. The vehicle travelling prediction method according to claim 1, further comprising, when the traffic light is in the first state where the current vehicle is allowed to cross the intersection, calculating a second estimated travelling time period t02 in accordance with travelling information about the current vehicle and the first distance.

6. The vehicle travelling prediction method according to claim 5, wherein prior to the step of acquiring the detection result of the vehicle in the same lane, the vehicle travelling prediction method further comprises determining whether or not there is the obstacle vehicle between the current vehicle and the intersection in the advancing direction of the current vehicle, and when there is the obstacle vehicle, detecting a speed of the obstacle vehicle and a fourth distance between the current vehicle and the obstacle vehicle, so as to acquire the detection result of the obstacle vehicle;
the step of outputting the prediction result indicating whether or not the current vehicle is capable of crossing the intersection in accordance with the first time period t1, the first distance and the detection result of the vehicle in the same lane comprises outputting a second prediction result indicating whether or not the current vehicle is capable of crossing the intersection in accordance with the first time period t1, the second estimated travelling time period t02 and the detection result of the obstacle vehicle; and
the prediction result indicating whether or not the current vehicle is capable of crossing the intersection comprises the second prediction result.

7. The vehicle travelling prediction method according to claim 6, wherein the step of calculating the second estimated travelling time period t02 in accordance with the travelling information about the current vehicle and the first distance comprises:
determining a second predetermined speed in accordance with speed information comprised in the travelling information about the current vehicle; and
calculating the second estimated travelling time period t02 in accordance with the first distance and the second predetermined speed, the second estimated travelling time period t02 being the first distance divided by the second predetermined speed.

8. The vehicle travelling prediction method according to claim 7, wherein the step of acquiring and outputting the second prediction result indicating whether or not the current vehicle is capable of crossing the intersection in accordance with the first time period t1, the second estimated travelling time period t02 and the detection result of the obstacle vehicle comprises:
comparing the first time period t1 with the second estimated travelling time period t02;
when the first time period t1 is greater than or equal to the second estimated travelling time period t02 and there is no obstacle vehicle between the current vehicle and the intersection in the advancing direction of the current vehicle, outputting the prediction result indicating that the current vehicle is capable of crossing the intersection at a speed greater than or equal to the second predetermined speed before the traffic light is changed to be in the second state; and
when the first time period t1 is greater than or equal to the second estimated travelling time period t02 and there is the obstacle vehicle between the current vehicle and the intersection in the advancing direction of the current vehicle, detecting the fourth distance between the current vehicle and the obstacle vehicle and the speed of the obstacle vehicle, and acquiring and outputting the prediction result in accordance with the first time period t1, the second predetermined speed, the fourth distance and the speed of the obstacle vehicle.

9. The vehicle travelling prediction method according to claim 8, wherein when the first time period t1 is greater than or equal to the second estimated travelling time period t02 and there is no obstacle vehicle between the current vehicle and the intersection in the advancing direction of the current vehicle, the vehicle travelling prediction method further comprises outputting a prompt information indicating that there is no obstacle vehicle in front of the current vehicle and the current vehicle is capable of being accelerated so as to facilitate the vehicle behind the current vehicle to cross the intersection.

10. The vehicle travelling prediction method according to claim 8, wherein the step of outputting the second prediction result indicating that the current vehicle is capable of crossing the intersection in accordance with the first time period t1, the second predetermined speed, the fourth distance and the speed of the obstacle vehicle comprises:
comparing the second predetermined speed and the speed of the obstacle vehicle;
when the second predetermined speed is smaller than or equal to the speed of the obstacle vehicle, outputting the prediction result indicating that the current vehicle is capable of crossing the intersection at a speed greater than or equal to the second predetermined speed before the traffic light is changed to be in the second state;
when the second predetermined speed is greater than the speed of the obstacle vehicle, calculating a second time period t2 within which the current vehicle is to run at the second predetermined speed in such a manner as to keep a predetermined safe distance from the obstacle vehicle in accordance with the second predetermined speed, the fourth distance and the speed of the obstacle vehicle, and comparing the second time period t2 with the first time period t1; and
when t2 is greater than or equal to t1, outputting the prediction result indicating that the current vehicle is capable of crossing the intersection at a speed greater than or equal to the second predetermined speed before the traffic light is changed to be in the second state;
when t2 is smaller than t1, calculating a third time period t3 within which the current vehicle is to cross the intersection at the speed of the obstacle vehicle when the predetermined safe distance is kept between the current vehicle and the obstacle vehicle;
comparing t1 with t2+t3;
when t1 is greater than or equal to t2+t3, outputting the prediction result indicating that the current vehicle is capable of crossing the intersection before the traffic light is changed to be in the second state; and
when t1 is smaller than t2+t3, outputting the prediction result indicating that the current vehicle is incapable of crossing the intersection before the traffic light is changed to be in the second state.

11. The vehicle travelling prediction method according to claim 10, further comprising, when t1 is greater than or equal to t2+t3, outputting information indicating that there is the obstacle vehicle in front of the current vehicle but the current vehicle is capable of being accelerated so as to facilitate the vehicle behind the current vehicle to cross the intersection before the traffic light is changed to be in the second state, and when t1 is smaller than t2+t3, outputting information indicating that there is the obstacle vehicle in front of the current vehicle and the current vehicle is incapable of being accelerated so as to facilitate the vehicle behind the current vehicle to cross the intersection before the traffic light is changed to be in the second state.

12. The vehicle travelling prediction method according to claim 8, wherein the step of detecting the fourth distance between the current vehicle and the obstacle vehicle and the speed of the obstacle vehicle comprises detecting the fourth distance between the current vehicle and the obstacle vehicle and the speed of the obstacle vehicle through a frequency-modulated continuous-wave radar.

13. The vehicle travelling prediction method according to claim 5, further comprising, when the first time period t1 is smaller than the second estimated travelling time period t02, outputting the prediction result indicating that the current vehicle is incapable of crossing the intersection before the traffic light is changed to be in the second state.

14. The vehicle travelling prediction method according to claim 1, further comprising, when the traffic light is in the second state where the current vehicle is not allowed to cross the intersection, detecting and outputting a time period t4 within which the traffic light is changed to be in the first state where the current vehicle is allowed to cross the intersection.

15. The vehicle travelling prediction method according to claim 1, further comprising detecting whether or not there is a vehicle of a specific type within a second predetermined distance from the current vehicle, and when there is the vehicle of the specific type, detecting travelling information about the vehicle of the specific type and outputting a corresponding prompt.

16. The vehicle travelling prediction method according to claim 15, wherein the step of detecting the travelling information about the vehicle of the specific type and outputting the corresponding prompt comprises:
when there is the vehicle of the specific type, determining whether the vehicle of the specific type is ahead of or behind the current vehicle;
when the vehicle of the specific type is behind the current vehicle, outputting the prompt indicating that the current vehicle is capable of changing its lane so as to avoid the vehicle of the specific type; and
when the vehicle of the specific type is ahead of the current vehicle, detecting a fifth distance between the current vehicle and the vehicle of the specific type, determining whether or not the current vehicle is capable of crossing the intersection at a speed greater than or equal to the second predetermined speed in accordance with the second predetermined speed, the travelling information about the vehicle of the specific type, the first distance and the fifth distance, and outputting the corresponding prediction result.

17-18. (canceled)

19. A vehicle travelling prediction device, comprising:
a traffic light determination unit configured to determine a state of a traffic light;
an acquisition unit configured to acquire a first distance between a current vehicle and an intersection where the traffic light is located in an advancing direction of the current vehicle, and when the traffic light is in a first state where the current vehicle is allowed to cross the intersection, acquire a first time period t1 within which the traffic light is changed to be in a second state where the current vehicle is not allowed to cross the intersection and acquire a detection result of a vehicle in a same lane, the detection result of the vehicle in the same lane comprising a detection result of a vehicle behind the current vehicle and/or a detection result of an obstacle vehicle; and
an output unit configured to output a prediction result indicating whether or not the current vehicle is capable of crossing the intersection in accordance with the first time period t1, the first distance and the detection result of the vehicle in the same lane.

20. The vehicle travelling prediction device according to claim 19, further comprising a traffic light detection unit,
wherein the acquisition unit comprises a first distance measurement unit;
the traffic light detection unit is configured to detect whether or not there is the traffic light within a first predetermined distance from the current vehicle in the advancing direction of the current vehicle, and when there is the traffic light, output a first control signal;
the traffic light determination unit is connected to the traffic light detection unit and further configured to, upon the receipt of the first control signal, determine the state of the traffic light, and when the traffic light is in the first state where the current vehicle is allowed to cross the intersection, detect the first time period t1 within which the traffic light is changed to be in the second state where the current vehicle is not allowed to cross the intersection; and
the first distance measurement unit is connected to the traffic light detection unit and configured to, upon the receipt of the first control signal, detect the first distance between the current vehicle and the intersection where the traffic light is located.

21. The vehicle travelling prediction device according to claim 19, wherein the acquisition unit comprises a first detection unit and a first calculation unit;
the first detection unit is configured to detect whether or not there is the vehicle behind the current vehicle, and when there is the vehicle behind the current vehicle, detect a speed of the vehicle behind the current vehicle, a second distance between the vehicle behind the current vehicle and the intersection, and a third distance between the current vehicle and the vehicle behind the current vehicle, so as to acquire the detection result of the vehicle behind the current vehicle;
the first calculation unit is connected to the traffic light determination unit, the first distance measurement unit and the first detection unit, and configured to acquire a first prediction result indicating whether or not the current vehicle is capable of crossing the intersection in accordance with the first time period t1, the first distance and the detection result of the vehicle behind the current vehicle;
the prediction result indicating whether or not the current vehicle is capable of crossing the intersection comprises the first prediction result; and
the output unit is connected to the first calculation unit and further configured to output the first prediction result.

22. The vehicle travelling prediction device according to claim 21, wherein the first calculation unit comprises a first predetermined speed determination module, a first estimated travelling time period calculation module, a first comparison module and a first calculation module;
the first predetermined speed determination module is connected to the first detection unit and configured to determine a first predetermined speed of the vehicle behind the current vehicle in accordance with the speed of the vehicle behind the current vehicle comprised in the detection result of the vehicle behind the current vehicle;
the first estimated travelling time period calculation module is connected to the first detection unit and the first predetermined speed determination module, and configured to calculate a first estimated travelling time period t01 in accordance with the second distance and the first predetermined speed, the first estimated travelling time period t01 being the second distance divided by the first predetermined speed;
the first comparison module is connected to the first estimated travelling time period calculation module and the traffic light determination unit, and configured to compare the first time period t1 with the first estimated travelling time period t01, when the first time period t1 is smaller than the first estimated travelling time period t01, output a twelfth control signal, and when the first time period t1 is greater than or equal to the first estimated travelling time period t01, output a thirteenth control signal;
the first calculation module is connected to the first comparison module, the traffic light determination unit, the first distance measurement unit and the first detection unit, and configured to, upon the receipt of the thirteenth control signal, calculate a threshold speed in accordance with the first time period t1, the first distance, the third distance and the first predetermined speed, and output a fourteenth control signal; and
the output unit is further connected to the first comparison module and the first calculation module, and further configured to, upon the receipt of the twelfth control signal, output the prediction result indicating that the vehicle behind the current vehicle is incapable of crossing the intersection before the traffic light is changed to be in the second state, and upon the receipt of the fourteenth control signal, output the prediction result indicating that the vehicle behind the current vehicle is capable of crossing the intersection at a speed greater than or equal to the first predetermined speed before the traffic light changes when a speed of the current vehicle is greater than or equal to the threshold speed, thereby to prompt the current vehicle to adjust its speed.

23-43. (canceled)
